(19) United States
(12) Patent Application Publication
(10) Pub. No.: US 2011/0084957 A1
(43) Pub. Date: Apr. 14, 2011

(54) PLASMA DISPLAY PANEL DRIVE CIRCUIT AND PLASMA DISPLAY DEVICE

(75) Inventors: Yasuhiro ARAI, Osaka (JP); Toshikazu WAKABAYASHI, Osaka (JP); Satoshi KOMINAMI, Osaka (JP); Masumi IZUCHI, Osaka (JP); Junko MATSUSHITA, Osaka (JP); Hiroyasu MAKINO, Osaka (JP); Hideki NAKATA, Osaka (JP)

(73) Assignee: PANASONIC CORPORATION, Osaka (JP)

(21) Appl. No.: 12/970,316

(22) Filed: Dec. 16, 2010

Related U.S. Application Data
(63) Continuation of application No. PCT/JP2009/002853, filed on Jun. 23, 2009.

(30) Foreign Application Priority Data
Jun. 26, 2008 (JP) 2008-166804
May 13, 2009 (JP) 2009-116662

(51) Int. Cl. G09G 5/00; G09G 3/28

(52) U.S. Cl. 345/212; 345/204; 345/60

(57) ABSTRACT

A plasma display panel drive circuit assures a sufficient number of subfields in a high resolution panel, is low cost, and is resistant to producing brightness differences. The plasma display panel drive circuit segments plural sustain electrodes into a first sustain electrode group and second sustain electrode group, applies sustain pulses in the sustain period, and includes the following devices: a sustain pulse generating circuit that generates sustain pulses; a specific voltage application circuit that applies a specific voltage to a first electrode path to the first sustain electrode group, and a second electrode path to the second sustain electrode group, at respective specific times; and a separation switch circuit that is connected between the sustain pulse generating circuit and the first electrode path and second electrode path, and electrically isolates the sustain pulse generating circuit from either the first electrode path or the second electrode path.

### CROSS-REFERENCE TO RELATED APPLICATIONS

This application is a continuation application of International Application No. PCT/JP2009/002853 filed Jun. 23, 2009, entitled “PLASMA DISPLAY PANEL DRIVE CIRCUIT AND PLASMA DISPLAY DEVICE” and claims priority to Japanese Patent Applications No. 2008-166804 filed Jun. 26, 2008 and No. 2009-116662 filed May 13, 2009, the contents of which are incorporated by reference herein.

### BACKGROUND OF THE INVENTION

1. Technical Field

The present invention relates to a plasma display panel drive circuit and to a plasma display device, and relates more particularly to a drive circuit that drives a plasma display panel and to a plasma display device that uses this drive circuit.

2. Related Art

Surface discharge AC display panels, of which a plasma display panel (simply “panel” below) is typical, have numerous discharge cells disposed between opposing front and back plates.

A plurality of parallel, alternating display electrode pairs each including a scan electrode and a sustain electrode are formed on the front plate, and a plurality of parallel data electrodes (address electrodes) are formed on the back plate. The front and back plates are disposed facing each other and sealed with the display electrode pairs and address electrodes perpendicular to each other, and the discharge space between the front and back plates is charged with a discharge gas. The discharge cells are formed in this space between the display electrode pairs and the address electrodes.

The panel is driven using a subfield drive method whereby one field is divided into plural subfields and gradations are displayed by controlling the combination of subfields.

Each subfield has an initialization period, an address period, and a sustain period. A priming discharge is produced in the initialization period in order to form the wall charge required in the following address operation. In the address period, an address discharge is selectively produced in the discharge cells according to the image to be displayed to produce a wall charge. In the sustain period, a sustain pulse voltage is alternately applied to the display electrode pairs to produce a sustain discharge, thereby causing the phosphor layers of the corresponding discharge cells to emit and display an image.

This separated address and sustain method in which the address period and sustain period are temporally separated so that they do not overlap by aligning the phase of the sustain period in all discharge cells is a commonly used subfield drive method. Because there is no time in this separated address and sustain method when discharge cells producing an address discharge and discharge cells producing a sustain discharge coexist, the panel can be driven under conditions optimal for an address discharge in the address period and conditions optimal for a sustain discharge in the sustain period. As a result, discharge control is relatively simple, and a relatively large drive margin can be set for the panel.

Conversely, if the time required for the address period becomes longer as panel resolution increases as a result of setting the sustain period in a period not including the address period with the separated address and sustain method, it may not be possible to secure enough subfields to improve image display quality.

To solve this problem, Japanese Unexamined Patent Appl. Pub. JP-A-2005-157338 teaches technology for dividing the display electrode pairs into plural groups, and driving the panel by shifting the subfield start time in each group so that the address periods of any two or more of the plural groups do not overlap temporally.

The drive circuit taught in JP-A-2005-157338, however, requires the same number of scan electrode drive circuits and sustain electrode drive circuits as the number of groups of display electrode pairs. As a result, the circuit design, such as the layout of the drive circuits and control signals, becomes more complicated and the cost of drive circuit manufacture rises. In addition, when driving a panel using a plurality of sustain electrode drive circuits, brightness differences result from variation in the sustain electrode drive circuits, and image display quality drops.

### SUMMARY OF THE INVENTION

A plasma display panel drive circuit and a plasma display device according to the present invention can assure a sufficient number of subfields in a high resolution panel, can be manufactured at a low cost, and are resistant to differences in display brightness.

A first aspect of the invention is a drive circuit for a plasma display panel that divides the plural sustain electrodes of the plasma display panel into at least a first sustain electrode group and a second sustain electrode group, and applies sustain pulses in a sustain period, the drive circuit including: a sustain pulse generating circuit that generates sustain pulses; a specific voltage application circuit that applies a specific voltage to a first electrode path to the first sustain electrode group, and a second electrode path to the second sustain electrode group at respective specific times; and a separation switch circuit that is connected between the sustain pulse generating circuit and the first electrode path and second electrode path, and electrically isolates the sustain pulse generating circuit from at least one of the first electrode path and second electrode path.

A plasma display device according to another aspect of the invention includes the plasma display panel described above, and the foregoing plasma display panel drive circuit.

### Effect of the Invention

The plasma display panel drive circuit and plasma display device according to the invention can, by using a separation switch circuit, enable a single sustain pulse generating circuit to apply sustain pulses to plural sustain electrode groups during respectively different sustain periods. As a result, a sufficient number of subfields and sustain pulses can be assured in a high resolution panel, and the resolution and brightness of the plasma display panel can be improved. In addition, because the parts count can be reduced and the circuit configuration simplified, the drive circuit can be provided at a low cost. Furthermore, by enabling a configuration that uses a single sustain pulse generating circuit, brightness differences can be suppressed and image display quality can be improved.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a plasma display panel for a plasma display device according to a first embodiment of the invention.

FIG. 2 shows the electrode arrangement of the plasma display panel of the same plasma display device.

FIG. 3 is a timing chart showing the subfield configuration of the plasma display device.

FIG. 4 is a waveform diagram showing the drive voltage signals applied to the electrodes of the plasma display panel of the plasma display device.

FIG. 5 is a block diagram of the plasma display device.

FIG. 6 is a circuit diagram of the scan electrode drive circuit of a plasma display panel according to the first embodiment of the invention.

FIG. 7 is a circuit diagram of the sustain electrode drive circuit of the plasma display panel drive circuit.

FIG. 8 is a waveform diagram of the operation of the sustain electrode drive circuit of the plasma display panel drive circuit.

FIG. 9 is a waveform diagram of another operation of the sustain electrode drive circuit of the plasma display panel drive circuit.

FIG. 10 is a circuit diagram of the sustain electrode drive circuit in a plasma display panel drive circuit according to a second embodiment of the invention.

FIG. 11 is a waveform diagram of the operation of the sustain electrode drive circuit of the plasma display panel drive circuit.

FIG. 12 is a circuit diagram of the sustain electrode drive circuit in the plasma display panel drive circuit according to a second embodiment of the invention.

FIG. 13 is a waveform diagram of the operation of the sustain electrode drive circuit of the plasma display panel drive circuit.

FIG. 14 is a circuit diagram of the plasma display panel drive circuit according to a fourth embodiment of the invention.

FIG. 15 is a waveform diagram describing the operation of the plasma display panel drive circuit.

### DETAILED DESCRIPTION OF THE PREFERRED EMBODIMENTS

Preferred embodiments of the present invention are described below with reference to the accompanying figures wherein elements expressing the same configuration, operation, and effect are identified by the same reference numeral.

### Embodiment 1

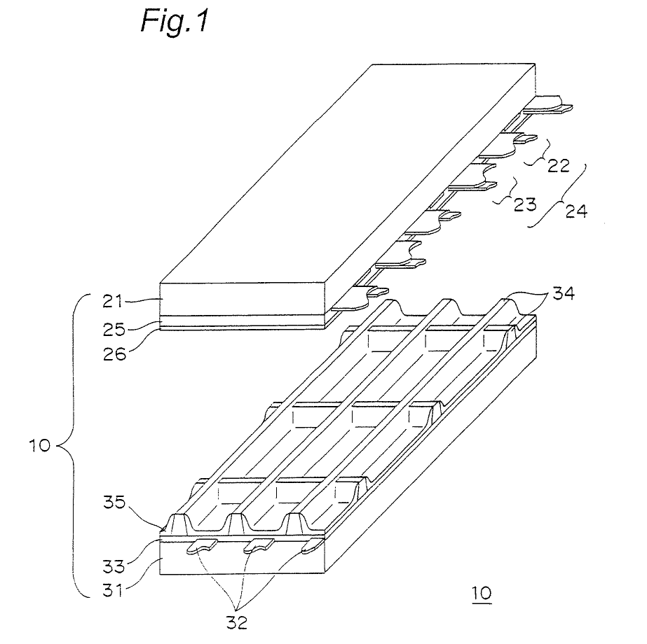

FIG. 1 is an exploded oblique view of a plasma display panel 10 (“panel” below) used in a plasma display device. A plurality of display electrode pairs 24 each composed of a scan electrode 22 and sustain electrode 23 are formed on a glass front plate 21. A dielectric layer 25 is formed covering the display electrode pairs 24, and a protective layer 26 is formed over the dielectric layer 25.

A plurality of data electrodes 32 are formed on a back plate 31, a dielectric layer 33 is formed covering the data electrodes 32, and barrier ribs 34 are formed thereon in a grid-like pattern of wells. A phosphor layer 35 that emits red (R), green (G), and blue (B) is disposed on the sides of the barrier ribs 34 and the top of the dielectric layer 33.

The front plate 21 and back plate 31 are then placed together so that the display electrode pairs 24 and data electrodes 32 intersect with small discharge spaces rendered therebetween, and the perimeter is then sealed with glass frit or other sealing material. A discharge gas of neon, argon, xenon or other rare gas, or a mixture of rare gases, is then injected to the internal discharge space. The discharge space is segmented into a plurality of cells by the barrier ribs 34, and the discharge cells are formed in the parts where the display electrode pairs 24 and data electrodes 32 intersect. An image is displayed by causing these discharge cells to discharge and emit.

It should be noted that the structure of the panel 10 is not limited to the foregoing. For example, the barrier ribs may be rendered in a striped pattern.

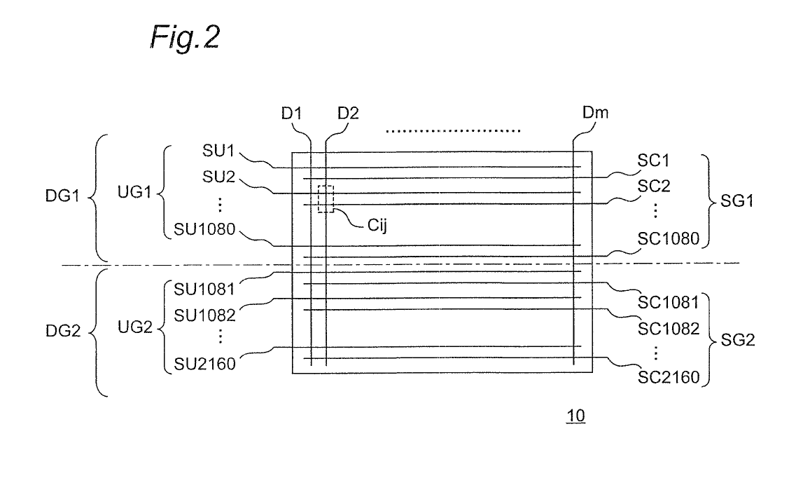

FIG. 2 shows the electrode arrangement of the plasma display device panel 10. As shown in the figure, n scan electrodes SC1, SC2 . . . SCn (scan electrodes 22 in FIG. 1) and n sustain electrodes SU1, SU2 . . . SUn (sustain electrodes 23 in FIG. 1) that are long in the row direction, and m data electrodes D1, D2 . . . Dm (data electrodes 32 in FIG. 1) that are long in the column direction, are formed on the panel 10. A discharge cell Cij (i=1-n; j=1-m) is formed where each display electrode pair n including a scan electrode SCi (i=1, 2, . . . n) and sustain electrode SUi (i=1 . . . n) pair intersects one data electrode Dj (j=1, 2, . . . m). There are m×n discharge cells Cij formed in the discharge space. The number of display electrode pairs is not specifically limited, and in the embodiment described below n=2160.

The 2160 display electrode pairs including scan electrodes SC1-SC2160 and sustain electrodes SU1-SU2160 are divided into plural display electrode pair groups DG1, DG2, . . . DGN. While the method of determining the number N of display electrode pair groups is further described below, the panel in this embodiment of the invention is divided in two parts top and bottom to render two display electrode pair groups DG1 and DG2.

As shown in FIG. 2, the display electrode pairs on the top half of the panel are display electrode pair group DG1, and the display electrode pairs on the bottom half of the panel are display electrode pair group DG2.

The 1080 scan electrodes SC1-SC1080 are scan electrode group SG1, and the 1080 sustain electrodes SU1-SU1080 are sustain electrode group UG1. In addition, the 1080 scan electrodes SC1081-SC2160 are scan electrode group SG2, and the 1080 sustain electrodes SU1081-SU2160 are sustain electrode group UG2. Scan electrode group SG1 and sustain electrode group UG1 thus belong to display electrode pair group DG1, and scan electrode group SG2 and sustain electrode group UG2 belong to display electrode pair group DG2.

The drive configuration for driving the panel 10 is described next. In this example the timing of the scan pulse and the address pulse is set, except during the initialization period, so that the address operation runs continuously. As a result, the greatest possible number of subfields can be set in one field period. This is described below in detail with reference to specific examples.

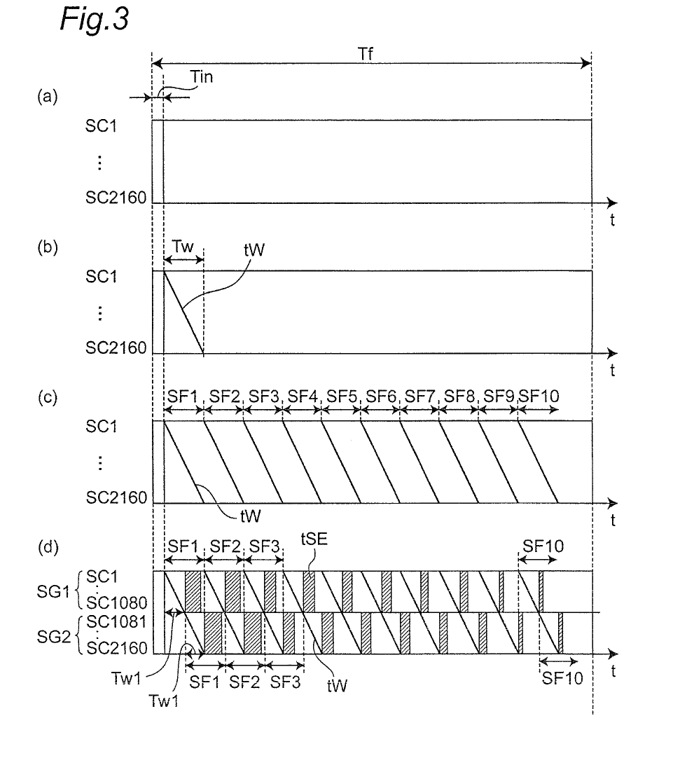

FIG. 3 is a timing chart showing the subfield configuration of the plasma display device. The y-axes in FIG. 3A, FIG. 3B, FIG. 3C, and FIG. 3D denote scan electrodes SC1-SC2160, and the x-axis denotes time t. The timing tW denoting the timing of the address (write) operation is indicated by the solid bold lines, and the sustain/erase period timing tSE denoting the timing of the sustain period and the erase period described below is indicated by the shading. Note that one field period Tf is 16.7 ms in the following example.

As shown in FIG. 3A, an initialization period Tin for producing an initialization discharge simultaneously in all discharge cells is provided at the beginning of one field period Tf. In this example the initialization period Tin is 500 μs.

As shown in FIG. 3B, the total write time Tw denoting the time required to sequentially apply a scan pulse to all scan electrodes SC1-SC2160 (that is, the time required to address all scan electrodes SC1-SC2160 once) is estimated. So that the address operation can execute continuously, the scan pulse is preferably as short as possible and is applied continuously as much as possible. In this example the time required to write one scan electrode is 0.7 μs. Because there are 2160 scan electrodes, the total write time Tw is 0.7×2160=1512 μs.

The subfield count is estimated next. The erase period is ignored at first. If the initialization period Tin is subtracted from one field period Tf and divided by the total write time Tw, (16.7−0.5)/1.5=10.8 ms is obtained. As a result, as shown in FIG. 3C, a maximum of 10 subfields SF1, SF2, . . . SF10 can be secured.

Next, based on the required number of scan pulses, the number of display electrode pair groups N representing the number of display electrode pair groups DG1, DG2, . . . DGN is determined. In this example the number of sustain pulses applied to the scan electrodes SC1-SC2160 in subfields SF1-SF10 is 60, 44, 30, 18, 11, 6, 3, 2, 1, and 1, respectively. The sustain period Ts1, Ts2, . . . , Ts10 denoting the time required to apply the sustain pulses is the product of the number of sustain pulses applied in subfields SF1 to SF10 times the sustain pulse period. If the sustain pulse period is 10 μs, the maximum sustain period Ts1 representing the maximum sustain period is 0.10×60=600 μs

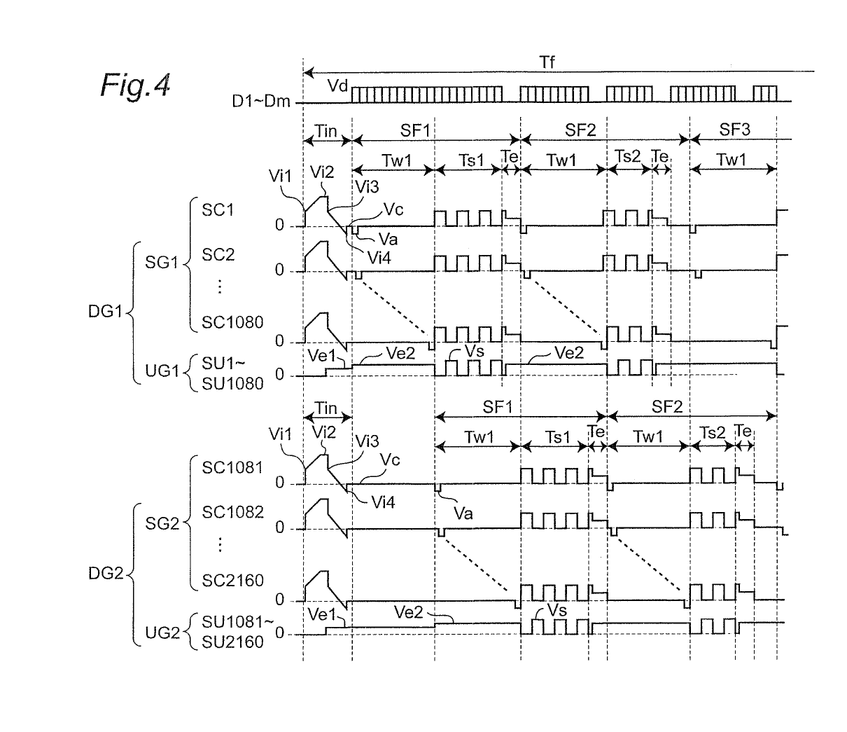

In FIG. 3D and FIG. 4 described below, the address period Tw1 represents the period in the total write time Tw required to address each display electrode pair group DG1-DGN, and is obtained from equation (1).

Tw1=Tw/N (1)

Sustain periods Ts1-Ts10 are provided in subfields SF1-SF10 after address period Tw1. The sustain period of subfield SFq (q=1-10) in display electrode pair group DGp (p=1-N) of display electrode pair groups DG1-DGN is set temporally parallel to the address period Tw1 of subfield SFq in each display electrode pair group DG (p+1)-DGN (where p=1, 2, . . . , N−1). In addition, the sustain period of subfield SFq of display electrode pair group DGp is set temporally parallel to the address period Tw1 of subfield SF(q+1) (where q=1-9) of each display electrode pair group DG1-DG (p−1) (where p=2, 3, . . . N).

The display electrode pair group count N is obtained as the lowest integer satisfying equation (2) below using the total write time Tw and the maximum sustain period Ts1.

N≧Tw/(Tw−Ts1) (2)

The derivation of equation (2) is described next. The original form of equation (2) is equation (3).

Ts1≦Tw×(N−1)/N (3)

Equation (3) shows that the period remaining after subtracting the group-unit address time Tw/N from the total write time Tw must not exceed the maximum sustain period Ts1. In other words, the display electrode pair group count N must be determined so that the period (Tw×(N−1)/N) on the right side of equation (3) is longer than the maximum sustain period Ts1. For example, if a small N that will not satisfy equation (3) is selected, the sustain period of subfield SFq in display electrode pair group DG (N−1) will not have ended when addressing subfield SFq in display electrode pair group DGN is completed. As a result, subfield SF(q+1) in display electrode pair group DG1 cannot be addressed immediately. As a result, writing continuously to the next subfield is not possible, and the drive time cannot be shortened. A natural number N that satisfies equation (3) must therefore be selected. Equation (2) is expressed as the result of the following derivation of equation (3).

As described above, because Tw=1512 μs and Ts1=600 μs,

1512/(1512−600)=1.66 (4)

is obtained from equation (2), and the display electrode pair group count N is 2.

Based on these considerations, the display electrode pairs are divided into two display electrode pair groups DG1, DG2 as shown in FIG. 2. In this configuration, because N=2, Tw=1512 μs, and Ts1=600 μs,

Tw×(N−1)/N=756≧600 (5)

and the condition of equation (3) is satisfied.

The drive configuration for driving the panel 10 and the display electrode pair group count N can be determined as described above. Note that the calculations described above ignore the erase period, but the address operation is preferably not executed during the erase period of any display electrode pair group. This is because the erase period is not only for erasing the wall voltage, but also for adjusting the wall voltage of the data electrodes in preparation for the address operation in the next address period Tw1, and the data electrode voltage is preferably fixed.

The drive voltage signal and operation are described in detail next.

FIG. 4 is a waveform diagram of the drive voltage signals applied to the electrodes of the panel 10 of the plasma display device. FIG. 4 shows, in order from the top, the drive voltage waveform of data electrodes D1-Dm; the drive voltage waveform of the scan electrode group SG1 and sustain electrode group UG1 in display electrode pair group DG1; and the drive voltage waveform of the scan electrode group SG2 and sustain electrode group UG2 in display electrode pair group DG2.

An initialization period Tin for producing an initialization discharge in each discharge cell Cij is provided at the beginning of one field period Tf. After the initialization period Tin in the one field period Tf, subfields SF1-SF10 are provided in display electrode pair groups DG1, DG2 as shown in FIG. 3D. Subfield SFq includes, in order, address period Tw1, sustain period Tsq, and erase period Te (q=1-10).

Erase period Te is a period provided after each sustain period Ts1-Ts10 to produce an erase discharge in the discharge cells that discharged in the sustain period. As described above in FIG. 3D, subfields SF1-SF10 in display electrode pair group DG2 are delayed overall by address period Tw1 from the subfields SF1-SF10 in display electrode pair group DG1. As a result, the sustain period Tsq and erase period Te of the display electrode pair group DG1 are temporally parallel to the address period Tw1 of subfield SFq in display electrode pair group DG2 (q=1-10).

The initialization period Tin is described next.

In the initialization period, Tin voltage 0 (V) is applied to data electrodes D1-Dm and sustain electrodes SU1-SU2160. A voltage with a slope that rises gradually from a positive voltage Vi1, which is lower than the positive discharge start voltage applied to sustain electrodes SU1-SU2160, to a positive voltage Vi2 that is greater than the discharge start voltage is applied to scan electrodes SC1-SC2160. While this slope waveform voltage rises, a weak initialization discharge is produced between the scan electrodes SC1-SC2160 and the sustain electrodes SU1-SU2160 and data electrodes D1-Dm. A negative wall voltage then accumulates on the scan electrodes SC1-SC2160, and a positive wall voltage accumulates on the data electrodes D1-Dm and sustain electrodes SU1-SU2160. The wall voltage on the electrodes represents the voltage produced by the wall charge stored in the dielectric layer covering the electrodes, the protective layer, and the phosphor layer. Note that voltage Vd may be applied to the data electrodes D1-Dm during this time.

Voltage 0 (V) is then applied to the data electrodes D1-Dm; a positive specific voltage Ve1 is applied to sustain electrodes SU1-SU2160; and a sloped waveform voltage that decreases gradually from a positive voltage Vi3 that is lower than the discharge start voltage applied to the sustain electrodes SU1-SU2160 to a negative voltage Vi4 that goes below the negative discharge start voltage is applied to the scan electrodes SC1-SC2160. A weak initialization discharge is produced during this time between the scan electrodes SC1-SC2160, the sustain electrodes SU1-SU2160, and the data electrodes D1-Dm. The negative wall voltage on the scan electrodes SC1-SC2160 and the positive wall voltage on the sustain electrodes SU1-SU2160 weaken, and the positive wall voltage on the data electrodes D1-Dm is adjusted to a value suitable for the address operation. Voltage Vc is then applied to the scan electrodes SC1-SC2160. As a result, the initialization operation producing an initialization discharge in all discharge cells ends.

The address period Tw1 of subfield SF1 in display electrode pair group DG1 is described next.

A positive specific voltage Ve2 that is higher than the specific voltage Ve1 is applied to sustain electrode group UG1. A scan pulse with a negative voltage Va is applied to scan electrode SC1, and an address pulse with a positive voltage Vd is applied to the data electrodes Dj (j=1-m) of the discharge cells that are to emit. The voltage difference at the intersection of data electrode Dj and scan electrode SC1 therefore goes to the sum of the external applied voltage (Vd−Va) plus the difference between the wall voltage on the data electrode Dj and the wall voltage on the scan electrode SC1, and exceeds the discharge start voltage. Discharge then starts between the data electrode Dj and scan electrode SC1, progresses to a discharge between the sustain electrode SU1 and scan electrode SC1, and an address discharge is produced. As a result, a positive wall voltage accumulates on the scan electrode SC1, a negative wall voltage accumulates on the sustain electrode SU1, and a negative wall voltage accumulates on the data electrode Dj. The address operation thus produces an address discharge in all discharge cells that are to emit on the first line, and stores a wall voltage on the electrodes. Because the voltage at the intersection of the scan electrode SC1 and the data electrodes D1 to Dm to which the address pulse was not applied does not exceed the discharge start voltage, an address discharge is not produced.

Next, a scan pulse is applied to the scan electrode SC2 on the second line, and an address pulse is applied to the data electrodes Dj of the discharge cells that are to emit. As a result, an address discharge is produced in the discharge cells of the second line to which a scan pulse and address pulse are simultaneously applied, and the discharge cells are addressed.

This address operation repeats to the discharge cells on line 1080, thereby selectively producing an address discharge and storing a wall charge on the discharge cells that are to emit.

In the address period Tw1 of subfield SF1 in display electrode pair group DG1, voltage Vc is applied to scan electrode group SG2 and specific voltage Ve1 is applied to sustain electrode group UG2. This address period Tw1 is a rest period in which the display electrode pair group DG2 is not made to discharge. The voltage applied to the electrodes in display electrode pair group DG2 is not limited to this voltage, however, and a different voltage may be applied insofar as it does not cause the cells to discharge.

The address period Tw1 of subfield SF1 in display electrode pair group DG2 is described next.

A positive specific voltage Ve2 is applied to sustain electrode group UG2. A scan pulse is applied to scan electrode SC1081, and an address pulse is applied to the data electrodes Dj of the discharge cells that are to emit. As a result, an address discharge is produced between data electrodes Dj and scan electrode SC1081, and between sustain electrode SU1081 and scan electrode SC1081. A scan pulse is then applied to scan electrode SC1082, and an address pulse is applied to the data electrodes Dj of the discharge cells that are to emit. As a result, an address discharge is produced in the discharge cells of line 1082 to which the scan pulse and address pulse were simultaneously applied. This address operation repeats to the discharge cells of line 2160, selectively producing an address discharge and storing a wall charge in the discharge cells that are to emit.

The address period Tw1 of subfield SF1 in display electrode pair group DG2 corresponds to the sustain period Ts1 of subfield SF1 in display electrode pair group DG1. More specifically, 60 sustain pulses are applied to scan electrode group SG1, and 60 sustain pulses are applied to sustain electrode group UG1 one at a time alternately to produce an address discharge and cause the discharge cells to emit.

More specifically, a positive sustain pulse voltage Vs is applied to scan electrode group SG1, and voltage 0 (V) is applied to sustain electrode group UG1. As a result, the sustain pulse voltage Vs is added to the wall voltage on the scan electrode SCi and the wall voltage on the sustain electrode SUi in the discharge cells that produced the address discharge, and the voltage difference of the scan electrode SCi and the sustain electrode SUi exceeds the discharge start voltage. A sustain discharge is therefore produced between the scan electrode SCi and sustain electrode SUi, and the resulting UV light causes the phosphor layer 35 to emit. A negative wall voltage accumulates on the scan electrode SCi, and a positive wall voltage accumulates on the sustain electrode SUi. In address period Tw1, a sustain discharge is not produced in the discharge cells that did not produce an address discharge, and the wall voltage is sustained at the end of the initialization period Tin.

Voltage 0 (V) is then applied to the scan electrode group SG1, and positive sustain pulse voltage Vs is applied to sustain electrode group UG1. As a result, because in the discharge cells that produced a sustain discharge the voltage difference between the sustain electrode SUi and the scan electrode SCi exceeds the discharge start voltage, a sustain discharge is again produced between the sustain electrode SUi and scan electrode SCi, and a negative wall voltage is stored on the sustain electrode SUi and a positive wall voltage is stored on the scan electrode SCi. Thereafter, a sustain pulse is alternately applied to the scan electrode group SG1 and sustain electrode group UG1, and a potential difference is applied between the electrodes of the display electrode pairs, to continuously produce a sustain discharge in the discharge cells that produced an address discharge in the address period Tw1, and the discharge cells emit.

An erase period Te is provided after the sustain period Ts1. In the erase period Te a so-called narrow pulse width voltage difference is applied between the scan electrodes SC1-SCn and sustain electrodes SU1-SUn, and the wall voltage on the scan electrodes SCi and sustain electrodes SUi is erased while leaving a positive wall voltage on the data electrodes Dj.

The address period Tw1 of subfield SF2 of the display electrode pair group DG1 is described next.

A positive specific voltage Ve2 is applied to the sustain electrode group UG1. Next, as in the address period Tw1 of subfield SF1, a scan pulse is sequentially applied to the scan electrode group SG1, and address pulse is applied to the data electrodes Dj, and the discharge cells on lines 1 to 1080 are addressed.

Address period Tw1 of subfield SF2 in display electrode pair group DG1 corresponds to the sustain period Ts1 of subfield SF1 in the display electrode pair group DG2. More specifically, 60 sustain pulses are alternately applied one at a time to the scan electrode group SG2 and sustain electrode group UG2 to produce an address discharge and cause the discharge cells to emit.

In the erase period Te following the sustain period Ts1, a voltage difference with a narrow pulse width is applied between the scan electrode group SG2 and sustain electrode group UG2, and the wall voltage on the scan electrode SCi and sustain electrode SUi is erased while leaving a positive wall voltage on the data electrode Dj.

Operation continues thereafter in the address period Tw1 of subfield SF2 in display electrode pair group DG2, the address period Tw1 of subfield SF3 in display electrode pair group DG1, and so forth to the address period Tw1 of subfield SF10 in display electrode pair group DG2, and the sustain period Ts10 and erase period Te of subfield SF10 in the last display electrode pair group DG2 to complete one field period Tf.

The timing of the scan pulse and address pulse is thus set so that after the initialization period Tin the address operation runs continuously on either display electrode pair group DG1 or DG2. More specifically, as shown in equation (6), one field period Tf is greater than or equal to the sum of the initialization period Tin, the total write time Tw of the subfields SF1-SF10 (Tw×10), the sustain period Ts10 of subfield SF10, and the erase period Te of subfield SF10.

Tf≧(Tin+Tw×10+Ts10+Te) (6)

The sustain period Ts1-Ts9 and erase period Te of subfields SF1-SF9 are temporally parallel to the total write time Tw of subfields SF1-SF10 (Tw×10), and can therefore practically be ignored.

As a result, ten subfields SF1-SF10 can be set in one field period Tf. As described above, the number of subfields SF1-SF10 is the maximum number that can be set in one field period Tf.

As described above, one field period Tf ends after the sustain period Ts10 and erase period Te of display electrode pair group DG2 (see equation (6)). As a result, sustain period Ts10 in equation (6) can be shortened by inserting a sustain period Ts10 with the lowest brightness weight in the last subfield SF10.

Note that as described above a voltage difference with a narrow pulse width is applied in the erase period Te between the scan electrodes SC1-SCn and sustain electrodes SU1-SUn to erase the wall voltage, and the erase period Te is ignored when determining the subfield configuration and display electrode pair group count N. The address operation also continues even if during the erase period Te of one of the display electrode pair groups DG1, DG2. However, an erase period Te is required for the erase operation, and the address operation preferably does not execute during the erase period Te of either display electrode pair group DG1, DG2.

The plasma display panel drive circuit is described next.

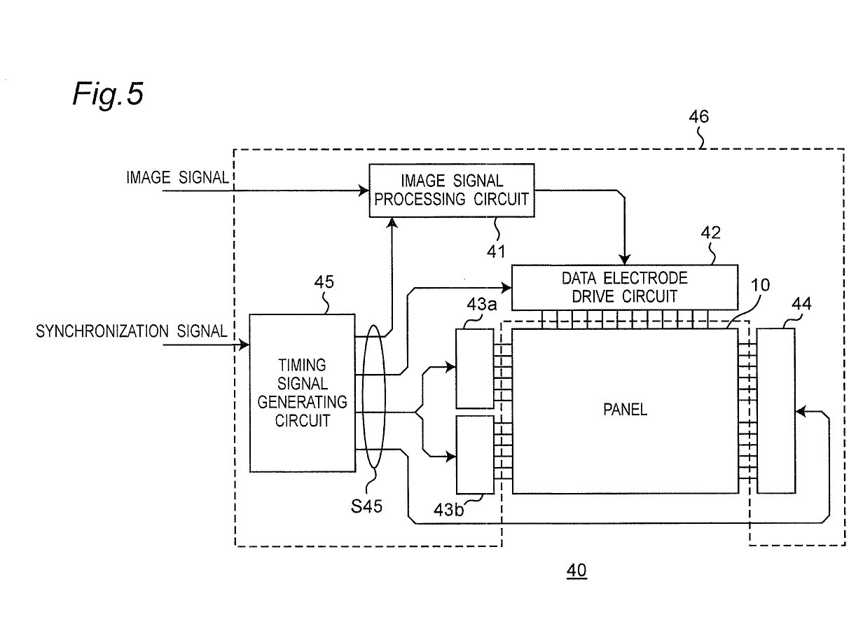

FIG. 5 is a block diagram of the plasma display device 40. The plasma display device 40 includes a plasma display panel drive circuit 46 and panel 10. The plasma display panel drive circuit 46 includes an image signal processing circuit 41, data electrode drive circuit 42, scan electrode drive circuit 43a, scan electrode drive circuit 43b, sustain electrode drive circuit 44, timing signal generating circuit 45, and a power supply circuit (not shown in the figure) that supplies power to the other circuit blocks.

The timing signal generating circuit 45 generates and supplies timing signals S45 to control operation of other circuits based on the horizontal synchronization signal and vertical synchronization signal of the image signal.

The image signal processing circuit 41 converts the image signal to image data denoting emit and non-emit states in each subfield based on the timing signals S45.

The data electrode drive circuit 42 has m switches for applying voltage Vd or voltage 0 (V) to the m data electrodes D1-Dm. Based on the timing signals S45, the data electrode drive circuit 42 converts the image data output from the image signal processing circuit 41 to address pulses corresponding to data electrodes D1-Dm, and applies the address pulses to the data electrodes D1-Dm.

Scan electrode drive circuit 43a drives the scan electrode group SG1 based on the timing signal S45, and scan electrode drive circuit 43b drives scan electrode group SG2 based on timing signal S45.

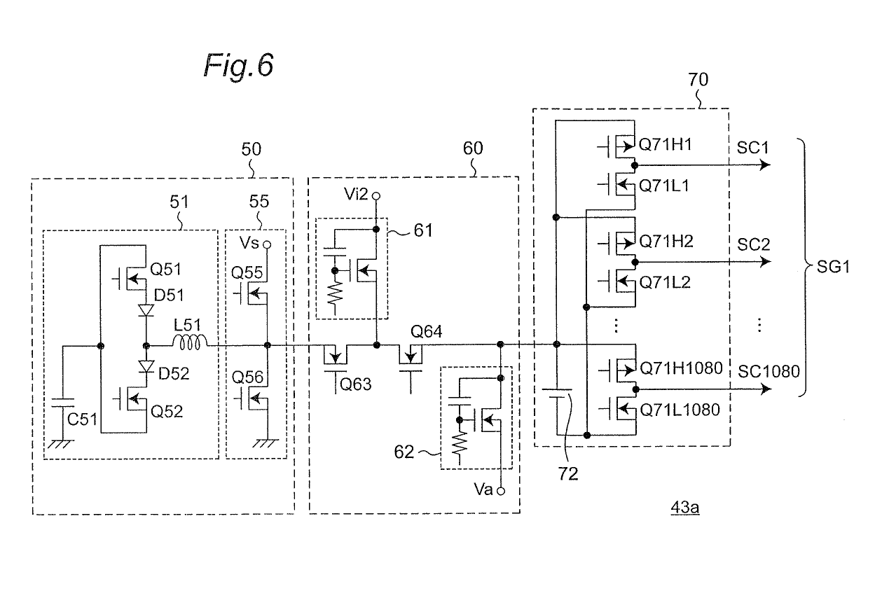

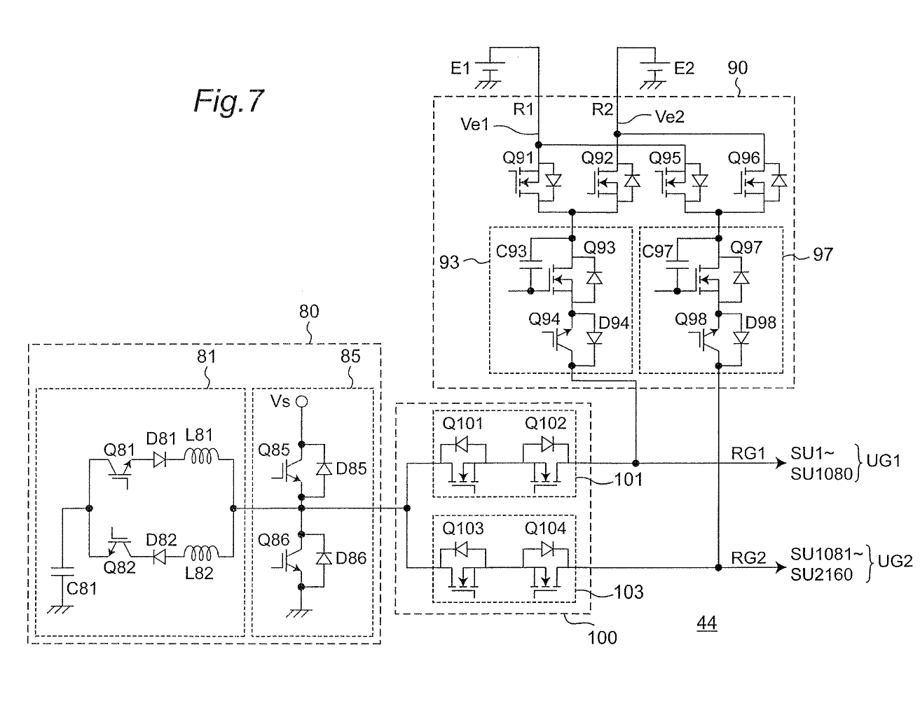

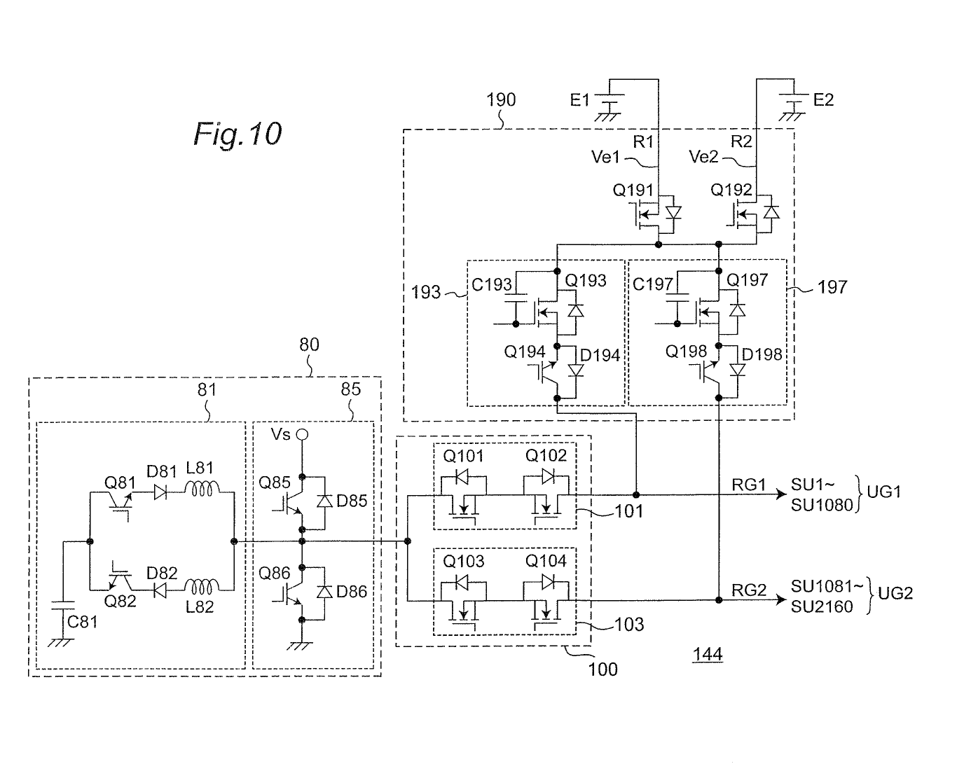

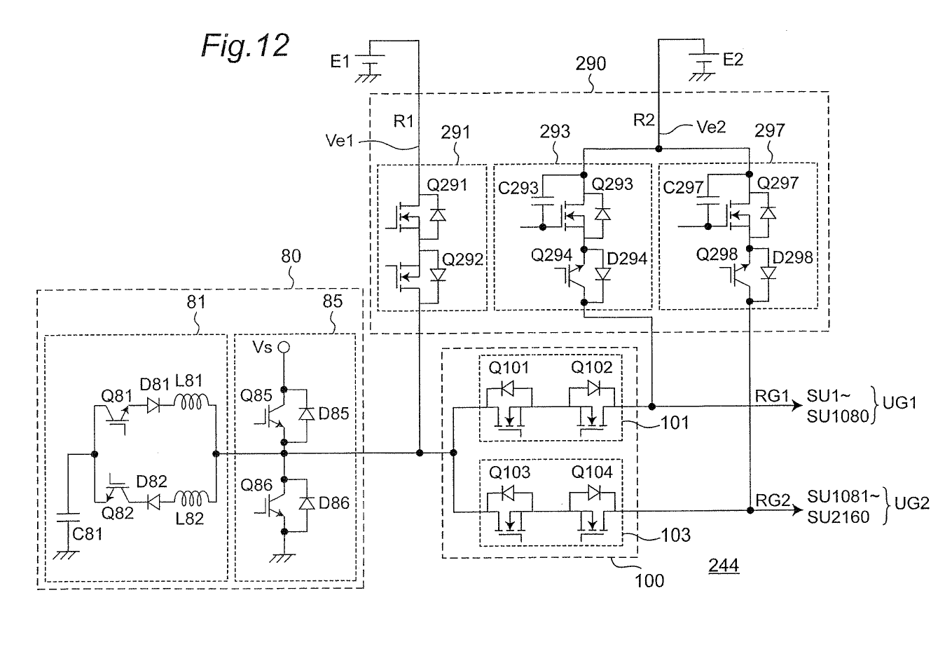

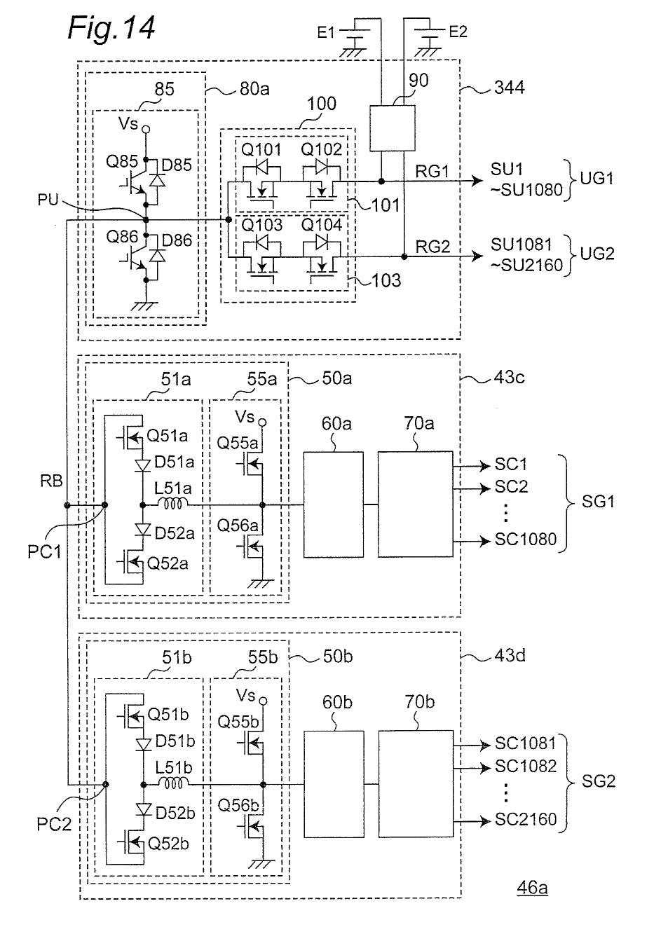

The sustain electrode drive circuit 44 drives sustain electrode groups UG1, UG2 based on the timing signal S45. Note that lines for the timing signals S45 from the timing signal generating circuit 45 are omitted for brevity in the exemplary circuit diagrams of the plasma display panel drive circuits 46, 46a according to the preferred embodiments shown in FIG. 6, FIG. 7, FIG. 10, FIG. 12, and FIG. 14.

FIG. 6 is a circuit diagram of the scan electrode drive circuit 43a of the plasma display panel drive circuit 46. The scan electrode drive circuit 43a includes a sustain pulse generating circuit 50, initialization signal generating circuit 60, and scan pulse generating circuit 70.

The sustain pulse generating circuit 50 has a power recovery unit 51, and a voltage clamp 55, and applies sustain pulses to the scan electrode group SG1.

The power recovery unit 51 includes a power recovery capacitor C51, switches Q51, Q52, reverse current prevention diodes D51 and D52, and resonance inductor L51. One end of capacitor C51 goes to ground, and the other end is connected to one side of switch Q51 and one side of switch Q52. The other side of switch Q51 is connected to the anode of diode D51, and the other side of switch Q52 is connected to the cathode of diode D52. The cathode of diode D51 and the anode of diode D52 are connected in common to one side of inductor L51, and the other side of inductor L51 is connected to a node between switch Q55 and switch Q56 of voltage clamp 55.

The power recovery circuit 51 LC resonates with inductor L51 and the 1080 interelectrode capacitances between the scan electrode group SG1 and sustain electrode group UG1 of display electrode pair group DG1, and raises and lowers the sustain pulses. When the sustain pulse rises, the power recovery circuit 51 supplies the charge (or power) stored in the power recovery capacitor C51 through switch Q51, diode D51, inductor L51, initialization signal generating circuit 60, scan pulse generating circuit 70, and scan electrode group SG1 to the 1080 interelectrode capacitances.

When the sustain pulse falls, the power recovery circuit 51 recovers the charge (or power) accumulated in the 1080 interelectrode capacitances from the scan electrode group SG1 through the scan pulse generating circuit 70, initialization signal generating circuit 60, inductor L51, diode D52, and switch Q52 to the power recovery capacitor C51. Because the power recovery unit 51 thus drives the scan electrode group SG1 by means of LC resonance without supplying power from the power supply, power consumption is ideally 0. Note that the capacity of the power recovery capacitor C51 is sufficiently greater than the 1080 interelectrode capacitances, and to function as the power supply of the power recovery unit 51 is charged to approximately Vs/2 or half the supply voltage Vs supplied for a sustain discharge.

The voltage clamp 55 has switches Q55, Q56. The scan electrode group SG1 is connected to the power supply through switch Q55, and is clamped to the supply voltage Vs when switch Q55 turns on.

Scan electrode group SG1 goes to ground through switch Q56, and is clamped to voltage 0 (V) when switch Q56 turns on.

The supply voltage Vs corresponds to the initial pulse voltage of the sustain pulse, and voltage 0 (V) corresponds to the reference voltage of the sustain pulse.

The voltage clamp 55 alternately clamps the scan electrode group SG1 to the initial pulse voltage of the sustain pulse and the pulse reference voltage in the sustain period to apply sustain pulses to the scan electrode group SG1. The impedance of the voltage clamp 55 is low when voltage is applied, and can stably pass the large discharge current of a strong sustain discharge.

The sustain pulse generating circuit 50 generates sustain pulses by controlling switches Q51, Q52, Q55, Q56 based on timing signals S45, and applies sustain pulses to the scan electrode group SG1 through initialization signal generating circuit 60 and scan pulse generating circuit 70. Note that these switches Q51, Q52, Q55, Q56 can be rendered using a MOSFET (Metal Oxide Semiconductor Field Effect Transistor), IGBT (Insulated Gate Bipolar Transistor), or other type of transistor device. FIG. 6 shows a circuit configuration using MOSFET devices as the switches. Note that the body diode of the MOSFETs are omitted from the figures for brevity.

The initialization signal generating circuit 60 includes Miller integrator 61, Miller integrator 62, switch Q63, and switch Q64.

Miller integrator 61 applies a gradually rising slope waveform voltage to scan electrode group SG1 in the initialization period Tin.

Miller integrator 62 applies a gradually falling slope voltage. Switches Q63, Q64 are separation switches, and are provided to prevent reverse current flow through the parasitic diodes of switches in the sustain pulse generating circuit 50 and initialization signal generating circuit 60. The initialization signal generating circuit 60 applies an initialization pulse to the scan electrode group SG1 by controlling Miller integrator 61, 62 and switch Q63, Q64 based on timing signal S45.

The scan pulse generating circuit 70 has switches Q71H1 and Q71L1 for applying a negative voltage Va scan pulse to scan electrode SC1; switches Q71H2 and Q71L2 for applying the scan pulse to scan electrode SC2, and so forth to switches Q71H1080 and Q71L1080 for applying scan pulses to scan electrode SC1080. The scan pulse generating circuit 70 also has a power supply 72 for generating the negative voltage Va. The scan pulse generating circuit 70 applies negative voltage Va scan pulses to the scan electrode SCi (i=1 to 1080) by changing switch Q71Hi from on to off and simultaneously changing switch Q71Li from off to on based on timing signal S45. Scan pulses are thus sequentially applied to scan electrode group SG1 by the scan pulse generating circuit 70 controlling switch Q71H1-Q71H1080 and Q71L1-Q71L1080 based on timing signal S45.

The scan electrode drive circuit 43b is configured identically to scan electrode drive circuit 43a, and applies sustain pulses, initialization pulses, and scan pulses to scan electrode group SG2.

FIG. 7 is a circuit diagram of the sustain electrode drive circuit 44 of the plasma display panel drive circuit 46. The plural sustain electrodes SU1-SU2160 of the plasma display panel 10 are divided into sustain electrode group UG1 and sustain electrode group UG2. The sustain electrode drive circuit 44 applies sustain pulses in sustain periods Ts1-Ts10 to sustain electrode group UG1 and sustain electrode group UG2. The sustain electrode drive circuit 44 includes a sustain pulse generating circuit 80, specific voltage application circuit 90, separation switch circuit 100, electrode path RG1, and electrode path RG2. The separation switch circuit 100 is an example of a switching circuit.

The sustain electrode drive circuit 44 is connected to sustain electrode group UG1 through electrode path RG1, and to sustain electrode group UG2 through electrode path RG2.

Electrode path RG1 is an output path in the sustain electrode drive circuit 44 to the sustain electrode group UG1, or an input path from the sustain electrode group UG1.

Electrode path RG2 is an output path in sustain electrode drive circuit 44 to the sustain electrode group UG2, or an input path from the sustain electrode group UG2.

The sustain pulse generating circuit 80 includes a power recovery unit 81 and voltage clamp 85. The power recovery unit 81 includes power recovery capacitor C81, switches Q81 and Q82, reverse current prevention diodes D81 and D82, and resonance inductors L81 and L82. The voltage clamp 85 includes switches Q85 and Q86, and diodes D85 and D86.

One end of capacitor C81 goes to ground, and the other end is connected to one side of switch Q81 and one side of switch Q82. The other side of switch Q81 is connected to the anode of diode D81, and the other side of switch Q82 is connected to the cathode of diode D82.

The cathode of diode D81 is connected to one side of inductor L81, and the anode of diode D82 is connected to one side of inductor L82. The other side of inductor L81 and the other side of inductor L82 are commonly connected to a node between switch Q85 and switch Q86 in the voltage clamp 85.

Note that the sustain pulse generating circuit 80 is shown having two resonance inductors L81, L82, but can be rendered with the same configuration as sustain pulse generating circuit 50, that is, with one resonance inductor.

MOSFET, IGBT, or other type of transistor device can be used for the switches of the sustain pulse generating circuit 80. A design using IGBT devices is shown in FIG. 7. More particularly, when IGBT devices are used as switches Q85, Q86 of the voltage clamp 85, a current path in the opposite direction as the forward path of the controlled current (that is, the direction of forward flow from the collector to the emitter) must be provided to assure the required reverse voltage resistance of the IGBT devices. As a result, diode D85 is parallel connected to switch Q85 so that the forward current flows in opposite directions, and diode D86 is parallel connected to switch Q86 so that the forward current flows in opposite directions.

Although not shown in FIG. 7, diodes may be similarly parallel connected to switch Q81 and switch Q82 for IGBT protection.

The operation of the sustain pulse generating circuit 80 is identical to the operation of the sustain pulse generating circuit 50. That is, at the sustain pulse rise, power recovery unit 81 supplies the charge (or power) stored in power recovery capacitor C81 through switch Q81, diode D81, inductor L81, separation switch circuit 100, and either electrode path RG1 or RG2 to the interelectrode capacitances of the 1080 sustain electrodes in the sustain electrode group during the sustain period. When the sustain pulse falls, the power recovery unit 81 recovers the charge (or power) stored in the interelectrode capacitances of the 1080 sustain electrodes in the sustain electrode group during the sustain period through either electrode path RG1 or RG2, separation switch circuit 100, inductor L82, diode D82, and switch Q82 to the power recovery capacitor C81.

The voltage clamp 85 connects the 1080 sustain electrodes of the sustain electrode group during the sustain period to the power supply through switch Q85, and clamps the sustain electrodes to the supply voltage Vs when switch Q85 turns on. The voltage clamp 85 connects the 1080 sustain electrodes of the sustain electrode group during the sustain period to ground through switch Q86, and clamps the sustain electrodes to voltage 0 (V) when switch Q86

The supply voltage Vs corresponds to the pulse starting voltage of the sustain pulses, and voltage 0 (V) corresponds to the reference voltage of the sustain pulses. By alternately clamping the sustain electrode group during the sustain period to the pulse starting voltage of the sustain pulses and the reference voltage, the voltage clamp 85 applies sustain pulses to the sustain electrode group. The impedance of the voltage clamp 85 when voltage is applied is low, and the voltage clamp 85 can pass the large discharge current of a strong sustain discharge stably.

The sustain pulse generating circuit 80 generates sustain pulses by controlling the switches Q81, Q82, Q85, Q86 based on timing signal S45, and applies the sustain pulses through the separation switch circuit 100 to the electrode path RG1 to sustain electrode group UG1, or the electrode path RG2 to sustain electrode group UG2.

The specific voltage application circuit 90 includes supply path R1, power supply path R2, switch Q91, switch Q92, switch Q95, switch Q96, specific voltage switch unit 93, and specific voltage switch unit 97. Specific voltage switch unit 93 and specific voltage switch unit 97 are examples of a switch unit.

Specific voltage switch unit 93 includes switch Q93 and switch Q94, and specific voltage switch unit 97 includes switch Q97 and switch Q98.

Specific voltage source E1 generates specific voltage Ve1, and power supply path R1 receives the specific voltage Ve1.

Likewise, specific voltage source E2 generates specific voltage Ve2, and power supply path R2 receives specific voltage Ve2.

Switch Q91 is connected between power supply path R1 and one side of specific voltage switch unit 93, and switch Q92 is connected between power supply path R2 and one side of specific voltage switch unit 93. Switch Q95 is connected between power supply path R1 and one side of specific voltage switch unit 97, and switch Q96 is connected between power supply path R2 and one side of specific voltage switch unit 97. The other side of specific voltage switch unit 93 is connected to sustain electrode group UG1 (that is, electrode path RG1), and the other side of specific voltage switch unit 97 is connected to sustain electrode group UG2 (that is, electrode path RG2).

Switch Q93 and switch Q94 are two-way switches connected in series so that the forward directions of the controlled currents are opposite (that is, the forward current flow from drain to source or from collector to emitter). Specific voltage switch unit 93 is on when both switch Q93 and switch Q94 are simultaneously on, and off when simultaneously off.

Similarly, switch Q97 and switch Q98 form a two-way switch connected in series so that the forward directions of the controlled currents are opposite. Specific voltage switch unit 97 is on when both switch Q97 and switch Q98 are on, and off when both are off.

When specific voltage switch unit 93 is on, the specific voltage application circuit 90 applies specific voltage Ve1 to sustain electrode group UG1 when switch Q91 is on, and when switch Q92 is on, applies specific voltage Ve2 to sustain electrode group UG1.

Likewise, specific voltage application circuit 90 applies specific voltage Ve1 to sustain electrode group UG2 when voltage switch unit 97 is on and switch Q95 is on, and when switch Q96 turns on, applies specific voltage Ve2 to sustain electrode group UG2.

When specific voltage switch unit 93 turns off, the power supply paths R1, R2 and sustain electrode group UG1 are electrically isolated. Likewise, when specific voltage switch unit 97 is off, power supply paths R1, R2 and sustain electrode group UG2 are electrically isolated.

MOSFET, IGBT, or other type of transistor device can be used for the switches of the specific voltage application circuit 90. A design using IGBT devices is shown in FIG. 7. More particularly, when IGBT devices are used as switches Q94, Q98, a current path in the opposite direction as the forward path of the controlled current must be provided to assure the reverse voltage resistance of the IGBT devices. As a result, diode D94 is parallel connected to switch Q94 so that the forward current flows in opposite directions, and diode D98 is parallel connected to switch Q98 so that the forward current flows in opposite directions.

Switch Q94 is provided to pass current from the sustain electrode group UG1 to specific voltage source E1, E2, but switch Q94 can be omitted is current flows only from specific voltage source E1, E2 to the sustain electrode group UG1. The same applies to switch Q98, that is, it can be omitted if current flows only from specific voltage source E1, E2 to sustain electrode group UG2.

Capacitor C93 is connected between the gate and drain of switch Q93, and capacitor C97 is connected between the gate and drain of switch Q97. Capacitor C93 and C97 are disposed to slow the rise when applying specific voltage Ve1, Ve2, and are not necessarily required. Capacitors C93, C97 are particularly not needed if specific voltages Ve1, Ve2 change in steps. Note also that the MOSFET body diodes are shown in FIG. 7. By controlling switch Q91, Q92, Q95, Q96 and specific voltage switch unit 93, 97 based on the timing signal S45, the specific voltage application circuit 90 applies specific voltages Ve1, Ve2 to the sustain electrode group UG1 through electrode path RG1 or sustain electrode group UG2 through electrode path RG2.

Separation switch circuit 100 is connected between sustain pulse generating circuit 80 and sustain electrode group UG1 (that is, electrode path RG1), and is connected between sustain pulse generating circuit 80 and sustain electrode group UG2 (that is, electrode path RG2).

While applying the sustain pulses from the sustain pulse generating circuit 80 to one sustain electrode group, either sustain electrode group UG1 or sustain electrode group UG2, the separation switch circuit 100 electrically isolates the sustain pulse generating circuit 80 from the other sustain electrode group. More specifically, separation switch circuit 100 includes, separation switch unit 101 and separation switch unit 103. Separation switch unit 101 and separation switch unit 103 are examples of a switch unit. Separation switch unit 101 includes switch Q101 and switch Q102, and separation switch unit 103 includes switch Q103 and switch Q104. Separation switch unit 101 is connected between sustain pulse generating circuit 80 and sustain electrode group UG1 (that is, electrode path RG1), and separation switch unit 103 is connected between sustain pulse generating circuit 80 and sustain electrode group UG2 (that is, electrode path RG2).

Switch Q101 and switch Q102 are connected in series so that the forward direction of the controlled current is opposite, and form a two-way switch. Separation switch unit 101 is on with both switch Q101 and switch Q102 are on, and off when both are off.

Likewise, switch Q103 and switch Q104 are connected in series so that the forward direction of the controlled current is opposite, and form a two-way switch. Separation switch unit 103 is on both switch Q103 and switch Q104 are both on, and off when both are off.

When turned on in the sustain period Ts1-Ts10 of sustain electrode group UG1, separation switch unit 101 applies sustain pulses from sustain pulse generating circuit 80 to sustain electrode group UG1. Likewise, when turned on in the sustain period Ts1-Ts10 of sustain electrode group UG2, the separation switch unit 103 applies sustain pulses from sustain pulse generating circuit 80 to sustain electrode group UG2. While separation switch unit 101 applies sustain pulses to sustain electrode group UG1, separation switch unit 103 is off and electrically isolates sustain pulse generating circuit 80 and sustain electrode group UG2. Likewise, while separation switch unit 103 applies sustain pulses to sustain electrode group UG2, separation switch unit 101 is off and electrically isolates sustain pulse generating circuit 80 and sustain electrode group UG1. By thus controlling separation switch units 101, 103 based on timing signal S45, separation switch circuit 100 electrically isolates sustain pulse generating circuit 80 from one of the electrode paths, either electrode path UG1 or electrode path UG2.

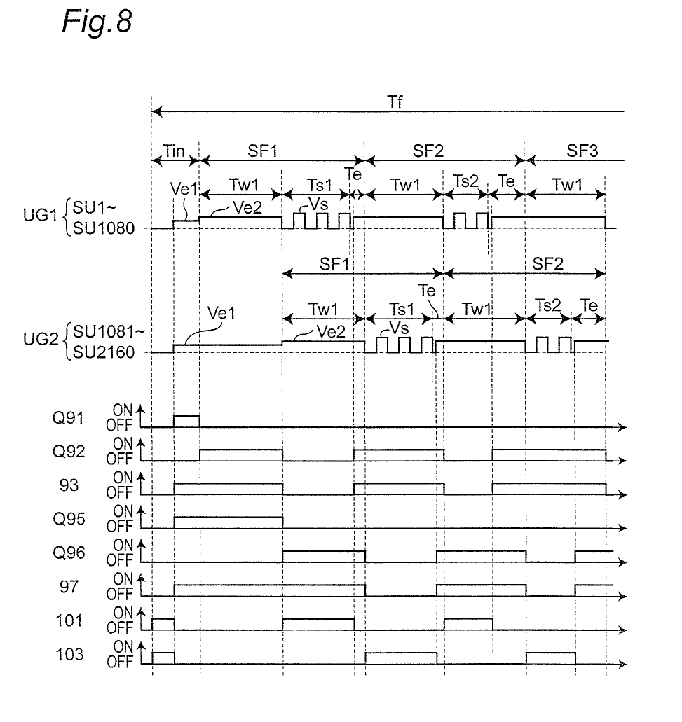

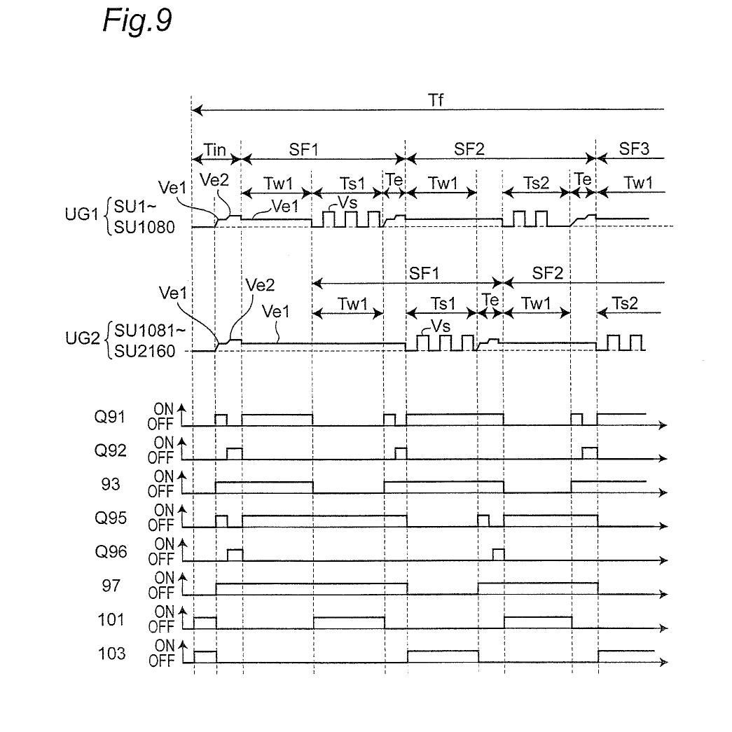

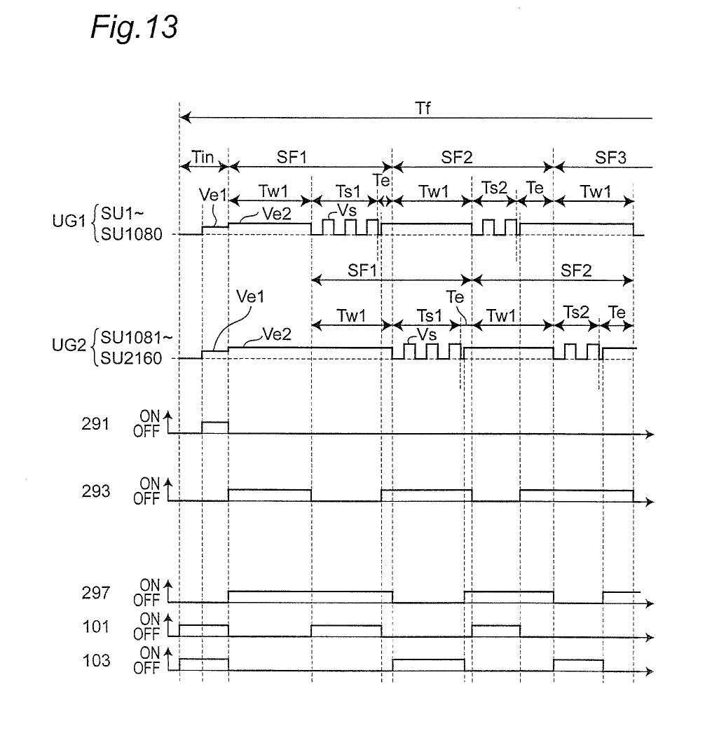

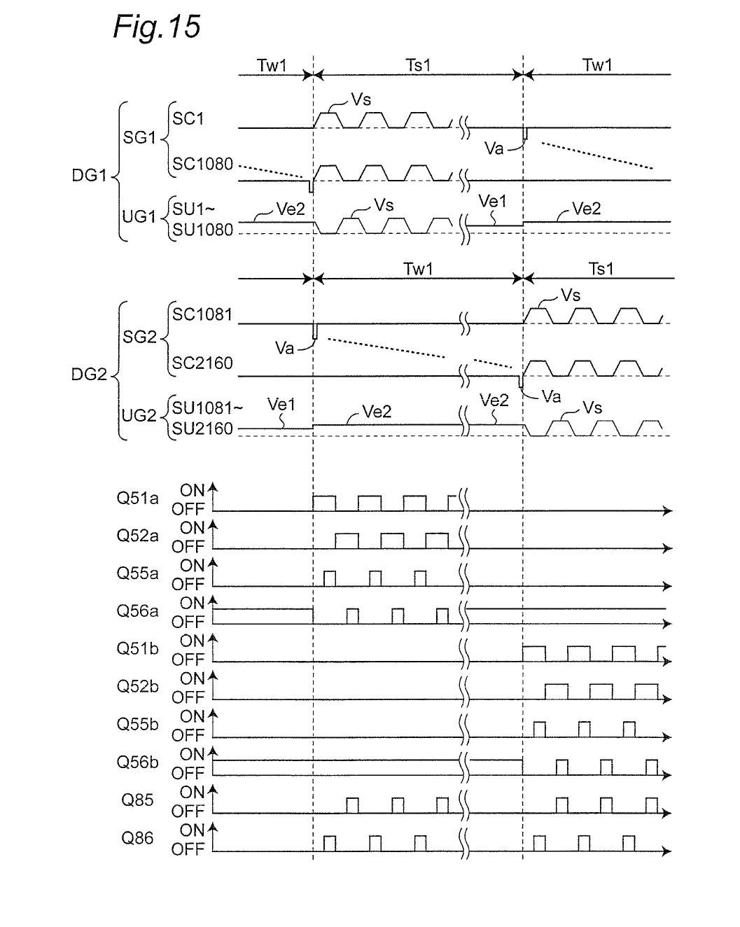

FIG. 8 is a waveform diagram showing the operation of the sustain electrode drive circuit 44 of the plasma display panel drive circuit 46. The top half of FIG. 8 shows the drive voltage signals applied to sustain electrode group UG1 and sustain electrode group UG2. The bottom half of FIG. 8 shows the on/off states of switch Q91 and Q92, specific voltage switch unit 93, switch Q95 and Q96, specific voltage switch unit 97, and separation switch unit 101 and 103 based on timing signals S45. These on/off states are denoted ON and OFF in FIG. 8, FIG. 9, FIG. 13, and FIG. 15.

To apply voltage 0 (V) to sustain electrode groups UG1, UG2 in initialization period Tin, switch Q86 of sustain pulse generating circuit 80 turns on. Specific voltage switch units 93, 97 turn off. Separation switch unit 101 also turns on so that sustain electrode group UG1 goes to ground, and separation switch unit 103 turns on so that sustain electrode group UG2 goes to ground.

Next, to apply specific voltage Ve1 to sustain electrode groups UG1, UG2, separation switch units 101, separation switch unit 103 turn off. Switch Q91 and specific voltage switch unit 93 also turn on, and apply specific voltage Ve1 to sustain electrode group UG1. Switch Q95 and specific voltage switch unit 97 also turn on and apply specific voltage Ve1 to sustain electrode group UG2.

In address period Tw1 of subfield SF1 in sustain electrode group UG1, switch Q91 is off and switch Q92 is on, and specific voltage Ve2 is applied to sustain electrode group UG1 through switch Q92 and specific voltage switch unit 93. During this time specific voltage Ve1 is continuously applied to sustain electrode group UG2.

Continuing, in sustain period Ts1 of subfield SF1 in sustain electrode group UG1, specific voltage switch unit 93 turns on and separation switch unit 101 turns on. The sustain pulses generated by the sustain pulse generating circuit 80 are applied to sustain electrode group UG1.

To generate sustain pulses in the sustain pulse generating circuit 80, switches Q81, Q85, Q86 turn off, switch Q82 then turns on, and the voltage of sustain electrode group UG1 is reduced to near voltage 0 (V) by LC resonance. Next, switch Q86 turns on and sustain electrode group UG1 is clamped to voltage 0 (V). Next, after switch Q82, Q86 turn off, switch Q81 turns on, and the voltage of sustain electrode group UG1 is raised to near supply voltage Vs by LC resonance. Next, switch Q85 turns on and sustain electrode group UG1 is clamped to voltage Vs.

By thereafter repeating this operation, sustain pulse generating circuit 80 can continue generating sustain pulses.

Because sustain electrode group UG2 is in address period Tw1 of subfield SF1 at this time, switch Q95 turns off and switch Q96 turns on to apply specific voltage Ve2 to sustain electrode group UG2.

Separation switch unit 101 turns off in the erase period Te of subfield SF1 in sustain electrode group UG1. Switch Q92 and specific voltage switch unit 93 then turn on to apply specific voltage Ve2 to sustain electrode group UG1. The on/off state of each switch is then held in the address period Tw1 of subfield SF2 in sustain electrode group UG1.

Because sustain electrode group UG2 is in sustain period Ts1 of subfield SF1 during the address period Tw1 of subfield SF2 in sustain electrode group UG1, specific voltage switch unit 97 turns off and separation switch unit 103 turns on. The sustain pulses generated by the sustain pulse generating circuit 80 are then applied to sustain electrode group UG2.

This operation thereafter continues to turn the separation switch units of separation switch circuit 100 off, turn the switches and specific voltage switch units of the specific voltage application circuit 90 on, and apply specific voltage Ve2 to the sustain electrodes of the sustain electrode group in the address period Tw1. In addition, the switches and specific voltage switch units of the specific voltage application circuit 90 turn off, and the separation switch units of the separation switch circuit 100 turn on, and sustain pulses generated by the sustain pulse generating circuit 80 are applied to the sustain electrodes of the sustain electrode group in the sustain period.

By repeating this operation, the drive voltage signals shown in FIG. 8 can be applied to the sustain electrodes of sustain electrode groups UG1, UG2.

As described above, the sustain electrode drive circuit 44 includes a sustain pulse generating circuit 80 that applies sustain pulses to sustain electrode group UG1, UG2; a specific voltage application circuit 90 that applies specific voltages Ve1, Ve2 to the sustain electrodes of sustain electrode groups UG1, UG2; and a separation switch circuit 100 that connects or electrically isolates the sustain pulse generating circuit 80 and the sustain electrodes of the sustain electrode group. As a result, by applying the sustain pulses generated by the sustain pulse generating circuit 80 to the sustain electrodes of the sustain electrode groups UG1, UG2, a simple sustain electrode drive circuit 44 that is resistant to producing brightness differences is achieved.

Note, also, that the sustain electrode drive circuit 44 can generate drive voltage waveforms other than those shown in FIG. 8.

FIG. 9 is a waveform diagram showing an example of other drive voltage waveforms that can be generated using the sustain electrode drive circuit 44 of the plasma display panel drive circuit 46. In this example, the capacitance of capacitors C93, C97 is increased, and the slope of the rise in specific voltage Ve1 and specific voltage Ve2 is reduced.

In the first half of the initialization period Tin, switch Q86 of the sustain pulse generating circuit 80 turns on, specific voltage switch units 93, 97 turn off, separation switch units 101, 103 turn on, and voltage 0 (V) is applied to sustain electrode groups UG1, UG2.

In the second half of the initialization period Tin, separation switch units 101, 103 turn off, switch Q91, Q95, and specific voltage switch units 93, 97 turn on, and specific voltage Ve1 is applied to sustain electrode group UG1, UG2. Next, switches Q91, Q95 turn off, switches Q92, Q96 turn on, and specific voltage Ve2 is applied to sustain electrode group UG1, UG2.

In address period Tw1 of subfield SF1 in sustain electrode group UG1, switch Q92 turns off, switch Q91 turns on, and specific voltage Ve1 is applied to sustain electrode group UG1. During this time, switch Q96 is off and switch Q95 is on, and specific voltage Ve1 is also applied to sustain electrode group UG2.

In the following sustain period Ts1 of subfield SF1 in sustain electrode group UG1, specific voltage switch unit 93 is turned off. Separation switch unit 101 is turned on, and the sustain pulses generated by the sustain pulse generating circuit 80 are applied to sustain electrode group UG1. During this time sustain electrode group UG2 is in the address period Tw1 of subfield SF1, and specific voltage Ve1 is continuously applied to sustain electrode group UG2.

Next, in the erase period Te of subfield SF1 in sustain electrode group UG1, drive voltage waveforms are applied in the same way as in the second half of initialization period Tin. That is, first, separation switch unit 101 is turned off, switch Q91 and specific voltage switch unit 93 are turned on, and specific voltage Ve1 is applied to sustain electrode group UG1. Switch Q91 then turns off, switch Q92 turns on, and specific voltage Ve2 is applied to sustain electrode group UG1. During this time, specific voltage Ve1 is continuously applied to sustain electrode group UG2.

In the following address period Tw1 of subfield SF2 in sustain electrode group UG1, switch Q92 is turned off, switch Q91 is turned on, and specific voltage Ve1 is applied to sustain electrode group UG2. During this time, because sustain electrode group UG2 is in the sustain period Ts1 of subfield SF1, specific voltage switch unit 97 is off and separation switch unit 103 is on. The sustain pulses generated by the sustain pulse generating circuit 80 are then applied to sustain electrode group UG2.

Next, in the erase period Te of subfield SF1 in sustain electrode group UG2, the same drive voltage waveform applied in the second half of the initialization period Tin is applied to sustain electrode group UG2. During this time specific voltage Ve1 is continuously applied to sustain electrode group UG1.

By repeating this operation, the drive voltage waveforms shown in FIG. 9 can be applied to the sustain electrodes of sustain electrode groups UG1, UG2.

By thus using a separation switch circuit 100 in the plasma display panel drive circuit according to the first embodiment of the invention, a single sustain pulse generating circuit 80 can apply sustain pulses to two sustain electrode groups UG1, UG2 in different sustain periods. Because a sufficient number of subfields and sustain pulses can thus be secured in a high definition panel, the resolution and brightness of a plasma display panel can be increased. In addition, because, the parts count can be reduced and the circuit design simplified, the drive circuit can be rendered at a low cost. In addition, by enabling a configuration that uses a single sustain pulse generating circuit 80, brightness differences can be suppressed and image display quality can be improved.

The foregoing first embodiment of the invention describes the circuit design of a sustain electrode drive circuit 44 that can apply drive voltage waveforms of any of the sustain pulses, specific voltage Ve1, and specific voltage Ve2 to the sustain electrode group UG2 at a desired timing. More specifically, specific voltages Ve1, Ve2 applied to sustain electrode groups UG1, UG2 can be different specific voltages at the same time. However, when the drive voltage waveforms that can be applied to the sustain electrodes of the sustain electrode groups are limited in any way, the circuit design of the sustain electrode drive circuit 44 can be simplified. The second embodiment and third embodiment described below describe the circuit design of a simplified sustain electrode drive circuit.

### Embodiment 2

FIG. 10 is a circuit diagram of sustain electrode drive circuit 144 in plasma display panel drive circuit 46. The sustain electrode drive circuit 144 includes sustain pulse generating circuit 80, specific voltage application circuit 190, and separation switch circuit 100. The sustain electrode drive circuit 144 is a circuit configuration that can be used when there is no time when specific voltage Ve1 is applied to the sustain electrodes of one sustain electrode group, and specific voltage Ve2 is simultaneously applied to the sustain electrodes of the other sustain electrode group.

This sustain electrode drive circuit 144 differs from sustain electrode drive circuit 44 in that the circuit design of the specific voltage application circuit 190 is simpler than the configuration of specific voltage application circuit 90. Only the differs between the specific voltage application circuit 190 and the specific voltage application circuit 90 are described below. Other aspects of the configuration and operation of the sustain electrode drive circuit 144 are the same as the sustain electrode drive circuit 44 described above, and further description thereof is omitted.

The specific voltage application circuit 190 includes a power supply path R1, power supply path R2, switch Q191, switch Q192, specific voltage switch unit 193, and specific voltage switch unit 197. The specific voltage switch unit 193 and specific voltage switch unit 197 are examples of a switch unit.

Specific voltage switch unit 193 includes switch Q193 and switch Q194, and specific voltage switch unit 197 includes switch Q197 and switch Q198. Switch Q191 is connected between power supply path R1 and a node between one side of specific voltage switch unit 193 and one side of specific voltage switch unit 197. Switch Q192 is connected between power supply path R2 and a node between one side of specific voltage switch unit 193 and one side of specific voltage switch unit 197. The other side of specific voltage switch unit 193 is connected to sustain electrode group UG1 (that is, electrode path RG1), and the other side of specific voltage switch unit 197 is connected to sustain electrode group UG2 (that is, electrode path RG2).

Switch Q193 and switch Q194 are connected in series so that the current normally flows in opposite directions through each, forming a two-way switch. Likewise, switch Q197 and switch Q198 are connected in series so that the current normally flows in opposite directions through each, forming a two-way switch.

When specific voltage switch unit 193 is on, the specific voltage application circuit 190 applies specific voltage Ve1 to sustain electrode group UG1 when switch Q191 turns on, and when switch Q192 turns on, applies specific voltage Ve2 to sustain electrode group UG1. Likewise, when specific voltage switch unit 197 is on and switch Q191 turns on, the specific voltage application circuit 190 applies specific voltage Ve1 to sustain electrode group UG2, and when switch Q192 turns on, applies specific voltage Ve2 to sustain electrode group UG2. In this case, switch Q191 passes specific voltage Ve1 to both sustain electrode groups UG1, UG2, and switch Q192 passes specific voltage Ve2 to both sustain electrode groups UG1, UG2. The specific voltages Ve1, Ve2 cannot be applied as different specific voltages at the same time to sustain electrode groups UG1, UG2. When specific voltage switch unit 193 is off, the power supply paths R1, R2 and sustain electrode group UG1 are electrically isolated. Likewise, turning specific voltage switch unit 197 off electrically isolates the power supply paths R1, R2 and sustain electrode group UG2.

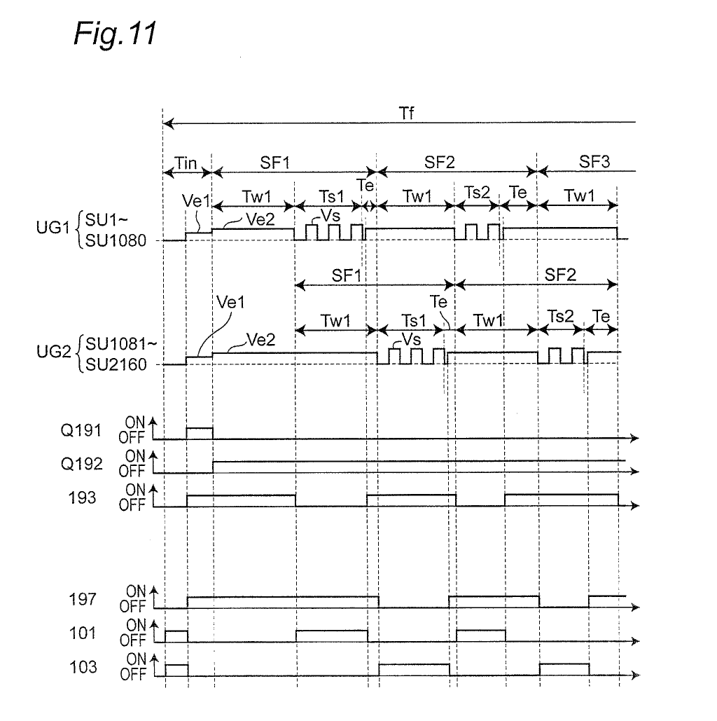

FIG. 11 is a waveform diagram describing the operation of the sustain electrode drive circuit 144 in plasma display panel drive circuit 46. The top half of FIG. 11 shows the drive voltage waveforms applied to sustain electrode group UG1, UG2. The bottom half of FIG. 11 shows the on/off operation of switch Q191 and Q192, specific voltage switch unit 193 and 197, and separation switch unit 101 and 103 based on timing signal S45.

To apply voltage 0 (V) to sustain electrode groups UG1, UG2 in initialization period Tin, switch Q86 of sustain pulse generating circuit 80 turns on. Specific voltage switch units 193, 197 turn off. In addition, separation switch unit 101 turns on so that sustain electrode group UG1 goes to ground, and separation switch unit 103 turns on so that sustain electrode group UG2 goes to grounds.

Next, to apply specific voltage Ve1 to sustain electrode groups UG1, UG2, separation switch units 101, 103 turn off. Switch Q191 and specific voltage switch unit 193 turn on to apply specific voltage Ve1 to sustain electrode group UG1, and specific voltage switch unit 197 turns on to apply specific voltage Ve1 to sustain electrode group UG2.

In the following address period Tw1 of subfield SF1 in sustain electrode group UG1, switch Q191 turns off and switch Q192 turns on to apply specific voltage Ve2 to sustain electrode group UG1 through switch Q192 and specific voltage switch unit 193. During this time specific voltage Ve2 is also applied to sustain electrode group UG2 through specific voltage switch unit 197, but a discharge is not produced and no drive problems occur.

In the following sustain period Ts1 of subfield SF1 in sustain electrode group UG1, specific voltage switch unit 193 turns off and separation switch unit 101 turns on, and the sustain pulses generated by the sustain pulse generating circuit 80 are applied to sustain electrode group UG1.

During this time sustain electrode group UG2 is in address period Tw1 of subfield SF1, and specific voltage Ve2 is continuously applied to sustain electrode group UG2.

In the following erase period Te of subfield SF1 in sustain electrode group UG1, separation switch unit 101 turns off. Switch Q192 and specific voltage switch unit 193 turn on, and specific voltage Ve2 is applied to sustain electrode group UG1. Next, in the address period Tw1 of subfield SF2 in sustain electrode group UG1, specific voltage Ve2 is continuously applied to sustain electrode group UG1.

In address period Tw1 of subfield SF2 in sustain electrode group UG1, sustain electrode group UG2 is in the sustain period Ts1 of subfield SF1, specific voltage switch unit 197 therefore turns off and separation switch unit 103 turns on. The sustain pulses generated by the sustain pulse generating circuit 80 are then applied to sustain electrode group UG2.

Thereafter, the separation switch unit corresponding to the separation switch circuit 100 turns off, the switch and specific voltage switch unit corresponding to specific voltage application circuit 190 turn on, and specific voltage Ve2 is applied to the sustain electrodes of the sustain electrode group during the address period Tw1. The switch and specific voltage switch unit corresponding to specific voltage application circuit 190 then turns off and the separation switch unit of the corresponding separation switch circuit 100 turns on to apply the sustain pulses generated by the sustain pulse generating circuit 80 to the sustain electrodes of the sustain electrode group during the sustain period.

By repeating this operation, the drive voltage waveforms shown in FIG. 11 can be applied to the sustain electrodes of sustain electrode groups UG1, UG2.

With the plasma display panel drive circuit according to the second embodiment of the invention, specific voltages Ve1, Ve2 will not be applied simultaneously as different specific voltages to sustain electrode group UG1 and sustain electrode group UG2. As a result, the plasma display panel drive circuit according to the second embodiment of the invention can be rendered using a specific voltage application circuit 190 that has fewer switches than specific voltage application circuit 90 described above, and can therefore be produced at an even lower cost.

### Embodiment 3

FIG. 12 is a circuit diagram of the sustain electrode drive circuit 244 in the plasma display panel drive circuit 46.

The sustain electrode drive circuit 244 includes a sustain pulse generating circuit 80, specific voltage application circuit 290, and separation switch circuit 100. The sustain electrode drive circuit 244 is a circuit configuration that can be used when there is no timing when sustain pulses are applied to the sustain electrodes of one sustain electrode group, and specific voltage Ve1 is simultaneously applied to the sustain electrodes of the other sustain electrode group.

Sustain electrode drive circuit 244 differs from sustain electrode drive circuit 44 in that the circuit design of specific voltage application circuit 290 is simplified, and the specific voltage application circuit 290 is divided into a circuit including specific voltage switch unit 291 and a circuit including specific voltage switch units 293 and 297. The differences between specific voltage application circuit 290 and specific voltage application circuits 90 and 190 described above are described below. Other aspects of the configuration and operation of sustain electrode drive circuit 244 are the same as sustain electrode drive circuit 44 and 144, and further description thereof is omitted.

Specific voltage application circuit 290 includes a power supply path R1, power supply path R2, specific voltage switch unit 291, specific voltage switch unit 293, and specific voltage switch unit 297. The specific voltage switch unit 291, specific voltage switch unit 293, and specific voltage switch unit 297 are examples of a switch unit. Specific voltage switch unit 291 includes switch Q291 and switch Q292. Specific voltage switch unit 293 includes switch Q293 and switch Q294. Specific voltage switch unit 297 includes switch Q297 and switch Q298. One side of specific voltage switch unit 291 is connected to power supply path R1, and one side of specific voltage switch units 293 and 297 are connected to power supply path R2. The other side of specific voltage switch unit 291 is connected through separation switch circuit 100 to sustain electrode group UG1, UG2. The other side of specific voltage switch unit 293 is connected to sustain electrode group UG1 (that is, electrode path RG1), and the other side of specific voltage switch unit 297 is connected to sustain electrode group UG2 (that is, electrode path RG2).

Switch Q291 and switch Q292 are connected in series so that the current normally flows in opposite directions through each, forming a two-way switch. Likewise, switch Q293 and switch Q294 are connected in series so that the current normally flows in opposite directions through each, forming a two-way switch. Likewise, switch Q297 and switch Q298 are connected in series so that the current normally flows in opposite directions through each, forming a two-way switch.

When specific voltage switch unit 293 turns on, specific voltage application circuit 290 applies specific voltage Ve2 to sustain electrode group UG1, and when specific voltage switch unit 297 turns on, applied specific voltage Ve2 to sustain electrode group UG2. In addition, when specific voltage switch unit 291 turns on, specific voltage application circuit 290 applies specific voltage Ve1 through separation switch circuit 100 to sustain electrode group UG1 and sustain electrode group UG2. In this case specific voltage Ve1 is applied to either sustain electrode group UG1 or UG2, and sustain pulses cannot be applied to the other sustain electrode group.

When specific voltage switch unit 293 turns off, power supply path R2 and sustain electrode group UG1 are electrically isolated. Likewise, when specific voltage switch unit 297 turns off, power supply path R2 and sustain electrode group UG2 are electrically isolated. Furthermore, when specific voltage switch unit 291 turns off, power supply path R1 and sustain pulse generating circuit 80 and separation switch circuit 100 are electrically isolated.

FIG. 13 is a waveform diagram describing the operation of the sustain electrode drive circuit 244 in plasma display panel drive circuit 46. The top half of FIG. 13 shows the drive voltage waveforms applied to sustain electrode groups UG1 and UG2. The bottom half of FIG. 13 shows the on/off states of the switches in specific voltage application circuit 290 and separation switch circuit 100 based on timing signal S45.

To apply voltage 0 (V) to sustain electrode groups UG1, UG2 in initialization period Tin, switch Q86 of sustain pulse generating circuit 80 turns on. Specific voltage switch units 293, 297 turn off. In addition, separation switch unit 101 turns on so that sustain electrode group UG1 goes to ground, and separation switch unit 103 turns on so that sustain electrode group UG2 goes to ground.

Next, to apply specific voltage Ve1 to sustain electrode groups UG1, UG2, switches Q81, Q82, Q85, Q86 of sustain pulse generating circuit 80 turn off, and specific voltage switch unit 291 turns on.

In the following address period Tw1 of subfield SF1 in sustain electrode group UG1, separation switch unit 101 turns off, specific voltage switch unit 293 turns on, and specific voltage Ve2 is applied to sustain electrode group UG1. Likewise, separation switch unit 103 turns off, specific voltage switch unit 297 turns on, and specific voltage Ve2 is also applied to sustain electrode group UG2.

In the following sustain period Ts1 of subfield SF1 in sustain electrode group UG1, specific voltage switch unit 293 turns off and separation switch unit 101 turns on. The sustain pulses generated by the sustain pulse generating circuit 80 are then applied to sustain electrode group UG1.

During this time sustain electrode group UG2 is in address period Tw1 of subfield SF1, and specific voltage Ve2 is continuously applied to sustain electrode group UG2.

Thereafter, the separation switch unit corresponding to the separation switch circuit 100 turns off, the specific voltage switch unit corresponding to specific voltage application circuit 290 turns on, and specific voltage Ve2 is applied to the sustain electrodes of the sustain electrode group during the address period Tw1. The specific voltage switch unit corresponding to specific voltage application circuit 290 then turns off and the separation switch unit of the corresponding separation switch circuit 100 turns on to apply the sustain pulses generated by the sustain pulse generating circuit 80 to the sustain electrodes of the sustain electrode group during the sustain period.

By repeating this operation, the drive voltage waveforms shown in FIG. 13 can be applied to the sustain electrodes of sustain electrode groups UG1, UG2.

With the plasma display panel drive circuit according to the third embodiment of the invention, while sustain pulses are being applied to sustain electrode group UG1 or sustain electrode group UG2, specific voltage Ve1 will not be applied to the other group. As a result, the plasma display panel drive circuit according to the third embodiment of the invention can be rendered using a specific voltage application circuit 290 that has fewer switches than specific voltage application circuit 90 described above, and can therefore be produced at an even lower cost.

Note that when only a specific voltage of Ve2 is required as the drive voltage waveform, and specific voltage Ve1 is not required, the specific voltage source E1, switch Q291 and switch Q292 shown in f12 can be omitted. Because this circuit design renders a specific voltage application circuit with an even smaller number of switches, the cost can be even further reduced.

Embodiments 2 and 3 describe circuits in which current flows from sustain electrode group UG1, UG2 to specific voltage source E1, E2, and from specific voltage source E1, E2 to sustain electrode group UG1, UG2. However, switches can be omitted when current flows only from specific voltage source E1, E2 to sustain electrode group UG1, UG2. In this configuration switches Q194 and Q198 can be omitted in embodiment 2, and in embodiment 3, switches Q294, Q298 can be omitted and a reverse current prevention diode used instead of switch Q292.

### Embodiment 4

A fourth embodiment of the invention is described next focusing on the differences with the foregoing first to third embodiments. Other aspects of the configuration, operation, and effect of the fourth embodiment are the same as the firs to third embodiments, and further description thereof is thus omitted.

FIG. 14 is a circuit diagram of the plasma display panel drive circuit 46a. The plasma display panel drive circuit 46a includes a scan electrode drive circuit 43c, scan electrode drive circuit 43d, sustain electrode drive circuit 344, and back path RB. The plasma display panel drive circuit 46a also has the same circuits as the plasma display panel drive circuit 46 described in FIG. 5. That is, plasma display panel drive circuit 46a includes a image signal processing circuit 41, data electrode drive circuit 42, timing signal generating circuit 45, and power supply circuit that supplies the necessary power to other circuit blocks. These other circuits are omitted from FIG. 14 for brevity, however.

Scan electrode drive circuit 43c also differs from scan electrode drive circuit 43a, scan electrode drive circuit 43d differs from scan electrode drive circuit 43b, and sustain electrode drive circuit 344 differs from sustain electrode drive circuit 44 (see FIG. 5, FIG. 6, and FIG. 7).

Scan electrode drive circuit 43c includes sustain pulse generating circuit 50a, initialization signal generating circuit 60a, and scan pulse generating circuit 70a. Sustain pulse generating circuit 50a includes voltage clamp 55a and power recovery unit 51a. Initialization signal generating circuit 60a, scan pulse generating circuit 70a, and voltage clamp 55a are configured identically to initialization signal generating circuit 60, scan pulse generating circuit 70, and voltage clamp 55, respectively (see FIG. 6). That is, the difference between scan electrode drive circuit 43c and scan electrode drive circuit 43a is the difference between power recovery unit 51a and power recovery unit 51. The difference between power recovery unit 51a and power recovery unit 51 is the elimination of power recovery capacitor C51, and the connection of back path RB to the node PC1 to which the eliminated capacitor C51 was connected.

Similarly to scan electrode drive circuit 43c, scan electrode drive circuit 43d includes sustain pulse generating circuit 50b, initialization signal generating circuit 60b, and scan pulse generating circuit 70b. Sustain pulse generating circuit 50b includes voltage clamp 55b and power recovery unit 51b. Sustain pulse generating circuit 50b, initialization signal generating circuit 60b, and scan pulse generating circuit 70b are configured identically to sustain pulse generating circuit 50a, initialization signal generating circuit 60a, and scan pulse generating circuit 70a, respectively. Power recovery unit 51b is configured identically to power recovery unit 51a, does not include a power recovery capacitor, and has back path RB connected to a node PC2 corresponding to node PC1.

Sustain electrode drive circuit 344 includes sustain pulse generating circuit 80a, specific voltage application circuit 90, separation switch circuit 100, electrode path RG1, and electrode path RG2. Sustain electrode drive circuit 344 differs from sustain electrode drive circuit 44 in that the configuration of sustain pulse generating circuit 80a differs from the configuration of sustain pulse generating circuit 80 (see FIG. 7, FIG. 10, and FIG. 12). Sustain pulse generating circuit 80a differs from sustain pulse generating circuit 80 in that power recovery unit 81 is omitted, and back path RB is connected to the node PU to which the eliminated power recovery unit 81 was connected.

As described above, there are three differences between plasma display panel drive circuit 46a and plasma display panel drive circuit 46. First, in scan electrode drive circuits 43c, 43d, the power recovery capacitors C51 of the scan electrode drive circuits 43a, 43b are omitted. Second, in sustain electrode drive circuit 344, the power recovery unit 81 of sustain electrode drive circuit 44 is omitted. Third, nodes PC1, PC2, and PU are connected to a common back path RB. The configuration, operation, and effect relating to these differences are described below.

In scan electrode drive circuit 43c, power recovery unit 51a includes switches Q51a and Q52a, reverse current prevention diodes D51a and D52a, and resonance inductor L51a. Voltage clamp 55a has switches Q55a and Q56a. One side of switch Q51a and one side of switch Q52a are connected through node PC1 to back path RB, the other side of switch Q51a is connected to the anode of diode D51a, and the other side of switch Q52a is connected to the cathode of diode D52a. The cathode of diode D51a and the anode of diode D52a are connected in common to one side of inductor L51a. The other side of inductor L51a is connected to a node between switch Q55a and switch Q56a in voltage clamp 55a.

In scan electrode drive circuit 43d, power recovery unit 51b includes switches Q51b and Q52b, reverse current prevention diodes D51b and D52b, and resonance inductor L51b. Voltage clamp 55b includes switches Q55b and Q56b. One side of switch Q51b and one side of switch Q52b are connected in common through node PC2 to back path RB. The other side of switch Q51b is connected to the anode of diode D51b, and the other side of switch Q52b is connected to the cathode of diode D52b. The cathode of diode D51b and the anode of diode D52b are connected in common to one side of inductor L51b. The other side of inductor L51b is connected to a node between switch Q55b and switch Q56b in voltage clamp 55b.

The power recovery unit 51a LC resonates as a result of controlling switches Q51a, Q52a based on signal S45. More specifically, the power recovery unit 51a produces LC resonance between inductor L51a and the 1080 interelectrode capacitances between the scan electrode group SG1 and sustain electrode group UG1 of display electrode pair group DG1, and causes the sustain pulses to rise and fall. At the rise of the sustain pulses in scan electrode group SG1, the power recovery unit 51a supplies the charge (or power) in the sustain electrode group UG1 through a specific scan electrode supply path to scan electrode group SG1. The specific scan electrode supply path is a path through electrode path RG1, separation switch unit 101, node PU, back path RB, node PC1, switch Q51a, diode D51a, inductor L51a, initialization signal generating circuit 60a, and scan pulse generating circuit 70a.

At the fall of the sustain pulses in scan electrode group SG1, the power recovery unit 51a recovers the charge (or power) in the scan electrode group SG1 through a specific scan electrode recovery path to sustain electrode group UG1. This specific scan electrode recovery path is a path through scan pulse generating circuit 70a, initialization signal generating circuit 60a, inductor L51a, diode D52a, switch Q52a, node PC1, back path RB, node PU, separation switch unit 101, and electrode path RG1.

As described above, the power recovery unit 51a recovers a charge (or power) from sustain electrode group UG1, and supplies the recovered charge (or power) directly to the scan electrode group SG1. As a result, the power recovery unit 51a raises the sustain pulses of the sustain electrode group UG1 and lowers the sustain pulses of the scan electrode group SG1 in parallel temporally. The power recovery unit 51a also recovers a charge (or power) from scan electrode group SG1, and supplies the recovered charge (or power) directly to sustain electrode group UG1. As a result, the power recovery unit 51a lowers the sustain pulses of the scan electrode group SG1 while raising the sustain pulses of the sustain electrode group UG1 in parallel temporally.

Power recovery unit 51b operates in the same way as recovery unit 51a. That is, power recovery unit 51b recovers a charge (or power) from sustain electrode group UG2, and supplies the recovered charge (or power) directly to scan electrode group SG2. As a result, power recovery unit 51b lowers the sustain pulses in the sustain electrode group UG2 and raises the sustain pulses in the scan electrode group SG2 in parallel temporally. In addition, power recovery unit 51b recovers a charge (or power) from scan electrode group SG2, and supplies the recovered charge (or power) directly to sustain electrode group UG2. As a result, power recovery unit 51b lowers the sustain pulses of scan electrode group SG2 and raises the sustain pulses of sustain electrode group UG2 in parallel temporally.

FIG. 15 is a waveform diagram describing the operation of the plasma display panel drive circuit 46a. The top half of FIG. 15 shows the drive voltage waveforms of the scan electrode group SG1 and sustain electrode group UG1 in the display electrode pair group DG1, and the drive voltage waveforms of the scan electrode group SG2 and sustain electrode group UG2 in display electrode pair group DG2. The bottom half of FIG. 15 shows the on/off states of switches Q51a, Q52a, Q55a, Q56a, Q51b, Q52b, Q55b, Q56b, Q85, and Q86 based on timing signal S45.

Just before the end of address period Tw1 in scan electrode group SG1, voltage 0 (V) is applied to scan electrode group SG1 and specific voltage Ve2 is applied to sustain electrode group UG1. In sustain period Ts1 after the address period Tw1 in scan electrode group SG1, separation switch unit 103 turns off and separation switch unit 101 turns on. At the beginning of sustain period Ts1, switches Q52a, Q55a, Q56a turn off, and switch Q51a turns on. At this time LC resonance is produced between inductor L51a and the 1080 interelectrode capacitances between the scan electrode group SG1 and sustain electrode group UG1 of display electrode pair group DG1. As a result, the voltage of scan electrode group SG1 rises from voltage 0 (V) to near voltage Vs, and the voltage of sustain electrode group UG1 simultaneously drops from voltage Ve2 to near voltage 0 (V).

Next, when switch Q55a and switch Q86 turn on, the voltage of scan electrode group SG1 is clamped to voltage Vs, and the voltage of sustain electrode group UG1 is clamped to voltage 0 (V). While the scan electrode group SG1 and sustain electrode group UG1 are clamped, discharge cell Cij emits. Next, switches Q51a, Q55a, Q86 turn off, and switch Q52a turns on. At this time LC resonance is again produced between the 1080 interelectrode capacitances and inductor L51a. As a result, the voltage of scan electrode group SG1 drops from voltage Vs to near voltage 0 (V), and the voltage of sustain electrode group UG1 simultaneously rises from voltage 0 (V) to near voltage Vs.

Next, when switch Q56a and switch Q85 turn on, the voltage of scan electrode group SG1 is clamped to voltage 0 (V), and the voltage of sustain electrode group UG1 is clamped to voltage Vs. Discharge cell Cij emits while scan electrode group SG1 and sustain electrode group UG1 are clamped.

Next, switch Q52a, Q56a, Q85 turn off, and switch Q51a turns on. At this time LC resonance is again produced between the 1080 interelectrode capacitances and inductor L51a. As a result, the voltage of scan electrode group SG1 rises from voltage 0 (V) to near voltage Vs, and the voltage of sustain electrode group UG1 simultaneously drops from voltage Vs to near voltage 0 (V).

By thereafter repeating this operation in sustain period Ts1, sustain pulse generating circuits 50a and 80a apply sustain pulses to display electrode pair group DG1, and cause discharge cells Cij (i=1-1080) to continue discharging.

During the sustain period Ts1 of scan electrode group SG1, scan electrode group SG2 is in the address period Tw1 and then goes to the sustain period Ts1 at the end of the address period Tw1. In the sustain period Ts1 of scan electrode group SG2, switches Q51b, Q52b, Q55b, Q56b, Q85, Q86 are controlled based on timing signal S45. The operation of these switches is the same as the operation of switch Q51a, Q52a, Q55a, Q56a, Q85, Q86 based on timing signal S45 in the sustain period Ts1 of scan electrode group SG1. As a result, sustain pulse generating circuit 50b and 80a apply sustain pulses to display electrode pair group DG2, and cause discharge cells Cij (i=1081-2160) to continue discharging.

Note that in the configuration shown in FIG. 14 the power recovery unit is included in the scan electrode drive circuits 43c, 43d and is not included in the sustain electrode drive circuit 344, but conversely could be included in the sustain electrode drive circuit 344 and not the scan electrode drive circuits 43c, 43d. In this configuration power recovery units 51a, 51b are omitted, and the back path RB is connected to a node between switch Q55a and switch Q56a, and a node between switch Q55b and switch Q56b. In addition, the sustain pulse generating circuit 80a is replaced by a circuit that omits the capacitance C81 from sustain pulse generating circuit 80, and connects the back path RB to the node to which the eliminated capacitor C81 was connected.

Note that the specific voltage application circuit 90 of the sustain electrode drive circuit 344 may be replaced by the specific voltage application circuit 190 shown in FIG. 10, or the specific voltage application circuit 290 shown in FIG. 12.

With the plasma display panel drive circuit 46a according to this fourth embodiment of the invention, the scan electrode drive circuits 43c, 43d and sustain electrode drive circuit 344 can share the power recovery unit. As a result, the parts count can be reduced according to the omitted power recovery unit, and the cost can be reduced.

Conclusion

As shown in FIG. 3, in the first to fourth embodiments described above, the subfield configuration is described as shifting the phase of all subfields in display electrode pair group DG1 and display electrode pair group DG2, but the invention is not limited to the subfield configurations described above. For example, the invention can also be applied to a subfield configuration containing some subfields that are controlled using a separated address and sustain method that aligns the sustain period phase of all discharge cells.

Note that when sustain pulses are simultaneously applied to all discharge cells, the interelectrode capacitance during the rise and fall of the sustain pulses is the interelectrode capacitance in the 2160 sustain electrodes. Therefore, the LC resonance period of the LC resonance inductor in the power recovery unit 81 and the interelectrode capacitance is longer than when sustain pulses are applied to one display electrode pair group (1080 sustain electrodes), and the timing signal preferably changes accordingly.

The foregoing first to fourth embodiments describe a configuration having two display electrode pair groups, but the invention can also be applied to configurations have three or more groups by adding some circuits. That is, when there are N groups, N separation switch units each having a switch configuration identical to separation switch unit 101 are disposed parallel to separation switch circuit 100. One side of each of the N separation switch units is connected in common to the sustain pulse generating circuit 80. The other sides of the N separation switch units are respectively connected to electrode paths RG1, RG2, . . . , RGN.

In addition, N specific voltage switch units with the same switch configuration as the specific voltage switch unit 93 are disposed parallel to the specific voltage application circuit. As in the third embodiment, one side of each of the N specific voltage switch unit is connected to one common power supply path, and as in the first and second embodiments through a switch to N power supply paths R1, R2, . . . , RN. The other sides of the N specific voltage switch units are connected to electrode paths RG1, RG2, . . . , RGN, respectively.

In the case of the third embodiment, one power supply path is connected to one specific voltage source, and in the case of the first and second embodiments, N power supply paths R1, R2, . . . , RN are respectively connected to N specific voltage sources. The electrode paths RG1, RG2, . . . , RGN are connected to sustain electrode groups UG1, UG2, . . . , UGN, respectively.

With this circuit configuration sustain pulses can be applied to each display electrode pair group from a single sustain pulse generating circuit even when there are N display electrode pair groups, the circuit configuration can therefore be simplified, and the manufacturing cost of the drive circuit can be reduced. In addition, brightness differences can be suppressed and image display quality can be improved.

Note that specific numeric values used in the foregoing embodiments are merely examples, and can obviously be appropriately set according to the panel characteristics and the plasma display device specifications, for example.

The invention can secure a sufficient number of subfields even in a high resolution panel, can provide a plasma display panel drive circuit that is simple and resistant to brightness differences, and is therefore useful as a plasma display device.

As described above, a plasma display panel drive circuit according to the foregoing embodiments of the invention has a separation switch circuit 100, thereby enabling a single sustain pulse generating circuit (80; 80a) to apply sustain pulses to plural sustain electrode groups UG1, UG2 in respectively different sustain periods. Because a sufficient number of subfields and sustain pulses can thus be secured in a high definition panel, a plasma display panel with high resolution and high luminance can be achieved. In addition, the parts count can be reduced and the circuit design can be simplified. Yet further, by enabling a configuration that uses a single sustain pulse generating circuit (80; 80a), brightness differences can be suppressed and image display quality can be improved.

It will be obvious to one with ordinary skill in the related art that the numbers cited above are used simply to specifically describe preferred embodiments of the invention, and the invention is not limited thereto. In addition, components that are rendered by hardware can also be rendered by software, and components that are rendered in software can also be rendered by hardware. In addition, different combinations of effects can also be achieved by rearranging some of the components described above in combinations different from those described in the foregoing embodiments.

### INDUSTRIAL APPLICABILITY

The present invention can be used in plasma display panel drive circuits and plasma display devices.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

It is to be noted that the present application is based on International application No. PCT/JP2009/002853 filed 23 Jun. 2009 which is herein incorporated by reference.

What is claimed is:

1. A drive circuit for a plasma display panel that divides plural sustain electrodes of a plasma display panel into at least a first sustain electrode group and a second sustain electrode group, and applies sustain pulses in a sustain period, the drive circuit comprising:
a sustain pulse generating circuit that generates sustain pulses; and
a separation switch circuit that is connected between the sustain pulse generating circuit and a first electrode path to the first sustain electrode group and a second electrode path to the second sustain electrode group, and applies sustain pulses generated by the sustain pulse generating circuit to the first electrode path and the second electrode path.

2. The plasma display panel drive circuit described in claim 1, wherein:
the separation switch circuit includes a first separation switch unit and a second separation switch unit,
the first separation switch unit is connected between the sustain pulse generating circuit and the first electrode path, and when turned on applies sustain pulses from the sustain pulse generating circuit to the first electrode path, and
the second separation switch unit is connected between the sustain pulse generating circuit and the second electrode path, and when turned on applies sustain pulses from the sustain pulse generating circuit to the second electrode path.

3. The plasma display panel drive circuit described in claim 2, wherein:
during a first state, one of the first separation switch unit and second separation switch unit is on and the other is off.

4. The plasma display panel drive circuit described in claim 3, wherein:
during a second state that is different from the first state, one of the first separation switch unit and second separation switch unit is on and the other is also on.

5. The plasma display panel drive circuit described in claim 2, wherein:
at least one of the first separation switch unit and second separation switch unit has two switching devices; and
the two switching devices are connected in series so that the forward directions are opposite.

6. The plasma display panel drive circuit described in claim 1, further comprising:
a specific voltage application circuit that applies a specific voltage to the first electrode path and second electrode path at respective specific times.

7. The plasma display panel drive circuit described in claim 6, wherein:
the specific voltage application circuit includes a first power supply path, a second power supply path, a first switch, a second switch, a third switch, a fourth switch, a first switch unit, and a second switch unit;
the first power supply path receives a first specific voltage from a first specific voltage source;
the second power supply path receives a second specific voltage from a second specific voltage source;
the first switch is connected between the first power supply path and first switch unit, and when on outputs the first specific voltage to the first switch unit;
the second switch is connected between the second power supply path and first switch unit, and when on outputs the second specific voltage to the first switch unit;
the third switch is connected between the first power supply path and second switch unit, and when on outputs the first specific voltage to the second switch unit;
the fourth switch is connected between the second power supply path and second switch unit, and when on outputs the second specific voltage to the second switch unit;
the first switch unit is connected between the first switch and second switch and the first electrode path, and when on applies the first specific voltage or second specific voltage to the first electrode path; and
the second switch unit is connected between the third switch and fourth switch and the second electrode path, and when on applies the first specific voltage or second specific voltage to the second electrode path.

8. The plasma display panel drive circuit described in claim 6, wherein:
the specific voltage application circuit includes a first power supply path, a second power supply path, a first switch, a second switch, a first switch unit, and a second switch unit;
the first power supply path receives a first specific voltage from a first specific voltage source;
the second power supply path receives a second specific voltage from a second specific voltage source;
the first switch is connected between the first power supply path and the first switch unit and second switch unit, and when on outputs the first specific voltage to the first switch unit and second switch unit;
the second switch is connected between the second power supply path and the first switch unit and second switch unit, and when on outputs the second specific voltage to the first switch unit and second switch unit;
the first switch unit is connected between the first switch and second switch and the first electrode path, and when on applies the first specific voltage or second specific voltage to the first electrode path; and
the second switch unit is connected between the first switch and second switch and the second electrode path, and when on applies the first specific voltage or second specific voltage to the second electrode path.

9. The plasma display panel drive circuit described in claim 6, wherein:
the specific voltage application circuit includes a first power supply path, a second power supply path, a first switch unit, a second switch unit, and a third switch unit;
the first power supply path receives a first specific voltage from a first specific voltage source;
the second power supply path receives a second specific voltage from a second specific voltage source;
the first switch unit is connected between the second power supply path and the first electrode path, and when on outputs the second specific voltage to the first electrode path;
the second switch unit is connected between the second power supply path and the second electrode path, and when on outputs the second specific voltage to the second electrode path;
the third switch unit is connected between the first power supply path and the separation switch circuit, and when on applies the first specific voltage through the separation switch circuit to the first electrode path and the second electrode path.

10. A plasma display device comprising:
the plasma display panel drive circuit described in claim 1; and
the plasma display panel.
